(19) United States
(12) Patent Application Publication
(10) Pub. No.: US 2016/0224479 A1
(43) Pub. Date: Aug. 4, 2016

(54) COMPUTER SYSTEM, AND COMPUTER SYSTEM CONTROL METHOD

(71) Applicant: HITACHI, LTD., Tokyo (JP)

(72) Inventors: Yo SHIGETA, Tokyo (JP); Yoshiaki EGUCHI, Tokyo (JP)

(73) Assignee: Hitachi, Ltd., Tokyo (JP)

(21) Appl. No.: 14/773,886

(22) PCT Filed: Nov. 28, 2013
(86) PCT No.: PCT/JP2013/082006

§ 371 Date: Sep. 9, 2015

(51) Int. Cl. G06F 13/16; G06F 3/06

(52) U.S. Cl. CPC G06F 13/1642; G06F 3/0665; G06F 3/0689; G06F 3/0613

(57) ABSTRACT

The computer system includes a server, and a storage system having two controllers. The server is connected to the two controllers, and has a dispatch module with a function to transfer an I/O request to the storage system to either one of the two controllers. When an I/O request is received from an MPU of the server, the dispatch module reads a transmission destination information of the I/O request from a dispatch table stored in the storage system, and based on the read transmission destination information, determines which of the two controllers the I/O request should be transferred to, and transfers the I/O request to the determined controller.

### TECHNICAL FIELD

The present invention relates to a method for dispatching an I/O request for a host computer in a computer system composed of a host computer and a storage system.

### BACKGROUND ART

Along with the advancement of IT and the spreading of the Internet, the amount of data handled in computers systems in companies and the like is rapidly increasing, and the storage systems for storing data are required to have enhanced performance. Therefore, many middle-scale and large-scale storage systems adopt a configuration loading multiple storage controllers for processing data access requests.

Generally, in a storage system having multiple storage controllers (hereinafter referred to as “controllers”), a controller in charge of processing an access request to respective volumes of the storage system is uniquely determined in advance. In a storage system having multiple controllers (controller 1 and controller 2), if the controller in charge of processing an access request to a certain volume A is controller 1, it is described that “controller 1 has ownership of volume A”. When an access (such as a read request) to volume A from a host computer connected to the storage system is received by a controller that does not have ownership, the controller that does not have ownership first transfers the access request to a controller having ownership, and the controller having the ownership executes the access request processing, then returns the result of the processing (such as the read data) to the host computer via the controller that does not have ownership, so that the process has a large overhead. In order to prevent the occurrence of performance degradation, Patent Literature 1 discloses a storage system having a dedicated hardware (LR: Local Router) for assigning access requests to the controller having ownership. According to the storage system taught in Patent Literature 1, the LR provided to a host (channel) interface (I/F) receiving a volume access command from the host specifies the controller having the ownership, and transfers the command to that controller. Thereby, it becomes possible to assign processes appropriately to multiple controllers.

### CITATION LIST

### Patent Literature

[PTL 1] US Patent Application Publication No. 2012/0005430

### SUMMARY OF INVENTION

### Technical Problem

According to the storage system taught in Patent Literature 1, a dedicated hardware (LR) is disposed in a host interface of the storage system to enable processes to be assigned appropriately to controllers having ownership. However, in order to equip with the dedicated hardware, a space for mounting the dedicated hardware in the system must be ensured, and the fabrication costs of the system are increased thereby. Therefore, the disclosed configuration of providing a dedicated hardware can only be adopted in a large-scale storage system having a relatively large system scale.

Therefore, in order to prevent occurrence of the above-described performance deterioration in a middle or small-scale storage system, it is necessary to have the access request issued to a controller having the ownership at the time point when the host computer issues the access request to the storage system, but normally, the host computer side has no knowledge of which controller has the ownership of the access target volume.

### Solution to Problem

In order to solve the problem, the present invention provides a computer system composed of a host computer and a storage system, wherein the host computer acquires ownership information from the storage system, and based on the acquired ownership information, the host computer determines a controller being the command issue destination.

According to one preferred embodiment of the present invention, when the host computer issues a volume access command to the storage system, the host computer issues a request to the storage system to acquire information of the controller having ownership of the access target volume, and in response to the request, the host computer transmits a command to the controller having ownership based on the ownership information returned from the storage system. In another embodiment, the host computer issues a first request for acquiring information of the controller having ownership of the access target volume, and before receiving a response to the first request from the storage system, it can issue a second request for acquiring information of the controller having ownership of the access target volume.

### Advantageous Effects of Invention

According to the present invention, it becomes possible to prevent an I/O request to be issued from the host computer to a storage controller that does not have ownership, and to thereby improve the access performance.

### BRIEF DESCRIPTION OF DRAWINGS

FIG. 1 is a configuration diagram of a computer system according to Embodiment 1 of the present invention.

FIG. 2 is a view illustrating one example of a logical volume management table.

FIG. 3 is a view illustrating an outline of an I/O processing in the computer system according to Embodiment 1 of the present invention.

FIG. 4 is a view illustrating an address format of a dispatch table.

FIG. 5 is a view illustrating a configuration of a dispatch table.

FIG. 6 is a view illustrating the content of a search data table.

FIG. 7 is a view illustrating the details of a processing performed by a dispatch unit of the server.

FIG. 8 is a view illustrating a process flow according to a storage system when an I/O command is transmitted to a representative MP.

FIG. 9 is a view illustrating a process flow according to a case where the dispatch module receives multiples I/O commands.

FIG. 10 is a view illustrating a process flow performed by the storage system when one of the controllers is stopped.

FIG. 11 illustrates a view of a content of an index table.

FIG. 12 is a view showing respective components of the computer system according to Embodiment 2 of the present invention.

FIG. 13 is a configuration view of a server blade and a storage controller module according to Embodiment 2 of the present invention.

FIG. 14 is a concept view of a command queue of a storage controller module according to Embodiment 2 of the present invention.

FIG. 15 is a view illustrating an outline of an I/O processing in the computer system according to Embodiment 2 of the present invention.

FIG. 16 is a view illustrating an outline of an I/O processing in a computer system according to Embodiment 2 of the present invention.

FIG. 17 is a view illustrating a process flow when an I/O command is transmitted to a representative MP of a storage controller module according to Embodiment 2 of the present invention.

FIG. 18 is an implementation example (front side view) of the computer system according to Embodiment 2 of the present invention.

FIG. 19 is an implementation example (rear side view) of the computer system according to Embodiment 2 of the present invention.

FIG. 20 is an implementation example (side view) of the computer system according to Embodiment 2 of the present invention.

### DESCRIPTION OF EMBODIMENTS

Now, a computer system according to one preferred embodiment of the present invention will be described with reference to the drawings. It should be noted that the present invention is not restricted to the preferred embodiments described below.

### Embodiment 1

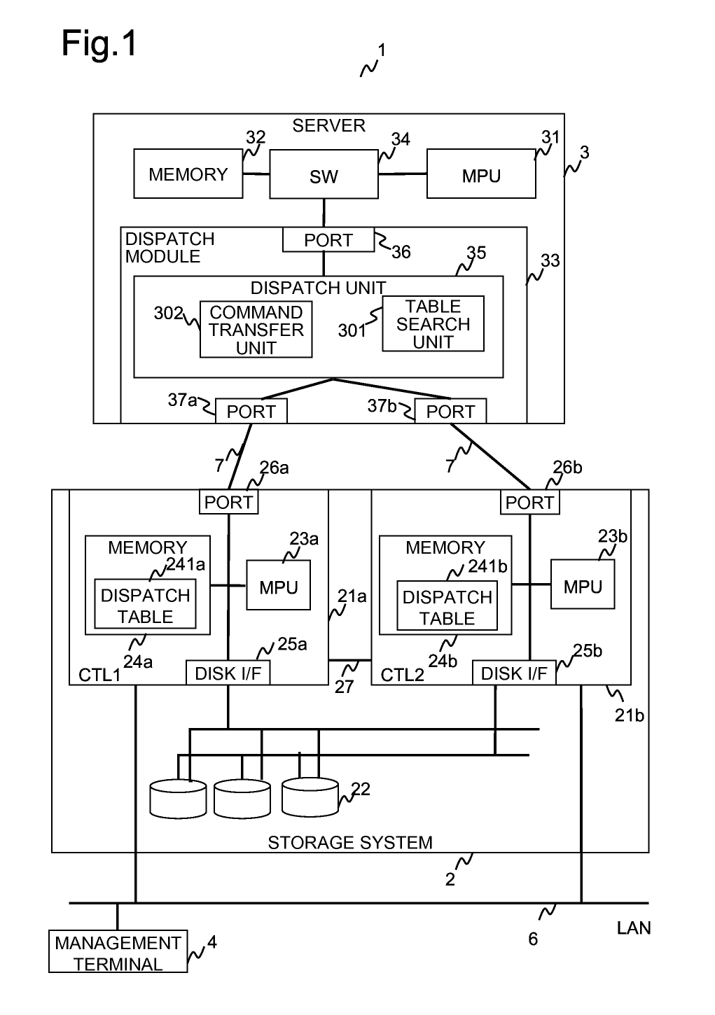

FIG. 1 is a view illustrating a configuration of a computer system 1 according to a first embodiment of the present invention. The computer system 1 is composed of a storage system 2, a server 3, and a management terminal 4. The storage system 2 is connected to the server 3 via an I/O bus 7. A PCI-Express can be adopted as the I/O bus. Further, the storage system 2 is connected to the management terminal 4 via a LAN 6.

The storage system 2 is composed of multiple storage controllers 21a and 21b (abbreviated as “CTL” in the drawing; sometimes the storage controller may be abbreviated as “controller”), and multiple HDDs 22 which are storage media for storing data (the storage controllers 21a and 21b may collectively be called a “controller 21”). The controller 21a includes an MPU 23a for performing control of the storage system 2, a memory 24a for storing programs and control information executed by the MPU 23a, a disk interface (disk I/F) 25a for connecting the HDDs 22, and a port 26a which is a connector for connecting to the server 3 via an I/O bus (the controller 21b has a similar configuration as the controller 21a, so that detailed description of the controller 21b is omitted). A portion of the area of memories 24a and 24b is also used as a disk cache. The controllers 21a and 21b are mutually connected via a controller-to-controller connection path (I path) 27. Although not illustrated, the controllers 21a and 21b also include NICs (Network Interface Controller) for connecting a storage management terminal 23. One example of the HDD 22 is a magnetic disk. It is also possible to use a semiconductor storage device such as an SSD (Solid State Drive), for example.

The configuration of the storage system 2 is not restricted to the one illustrated above. For example, the number of the elements of the controller 21 (such as the MPU 23 and the disk I/F 25) is not restricted to the number illustrated in FIG. 1, and the present invention is applicable to a configuration where multiple MPUs 23 or disk I/Fs 25 are provided in the controller 21.

The server 3 adopts a configuration where an MPU 31, a memory 32 and a dispatch module 33 are connected to an interconnection switch 34 (abbreviated as “SW” in the drawing). The MPU 31, the memory 32, the dispatch module 33 and the interconnection switch 34 are connected via an I/O bus such as PCI-Express. The dispatch module 33 is a hardware for performing control to selectively transfer a command (I/O request such as read or write) transmitted from the MPU 31 toward the storage system 2 to either the controller 21a or the controller 21b, and includes a dispatch unit 35, a port connected to a SW 34, and ports 37a and 37b connected to the storage system 2. A configuration can be adopted where multiple virtual computers are operating in the server 3. Only a single server 3 is illustrated in FIG. 1, but the number of servers 3 is not limited to one, and can be two or more.

The management terminal 4 is a terminal for performing management operation of the storage system 2. Although not illustrated, the management terminal 4 includes an MPU, a memory, an NIC for connecting to the LAN 6, and an input/output unit 234 such as a keyboard or a display, with which well-known personal computers are equipped. A management operation is specifically an operation for defining a volume to be provided to the server 33, and so on.

Next, we will describe the functions of a storage system 2 necessary for describing a method for dispatching an I/O according to Embodiment 1 of the present invention. At first, we will describe volumes created within the storage system 2 and the management information used within the storage system 2 for managing the volumes.

### (Logical Volume Management Table)

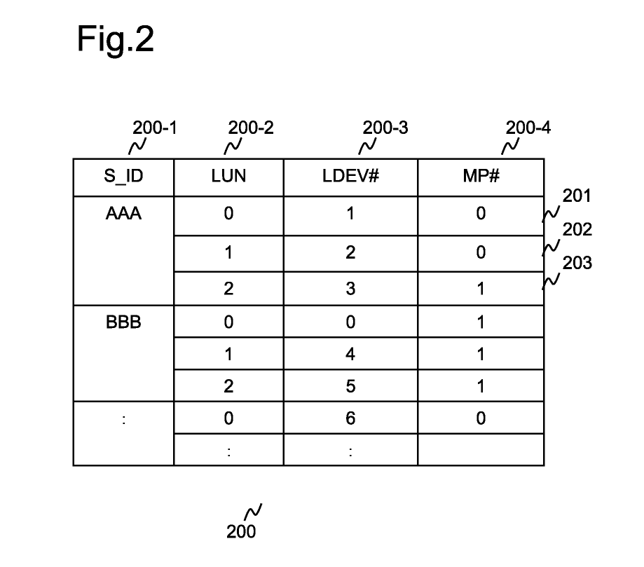

The storage system 2 according to Embodiment 1 of the present invention creates one or more logical volumes (also referred to as LDEVs) from one or more HDDs 22. Each logical volume has a unique number within the storage system 2 assigned thereto for management, which is called a logical volume number (LDEV #). Further, when the server 3 designates an access target volume when issuing an I/O command and the like, an information called S_ID, which is capable of uniquely identifying a server 3 within the computer system 1 (or when a virtual computer is operating in the server 3, information capable of uniquely identifying a virtual computer), and a logical unit number (the LUN), are used. That is, the server 3 uniquely specifies an access target volume by including S_ID and LUN in a command parameter of the I/O command, and the server 3 will not use LDEV # used in the storage system 2 when designating a volume. Therefore, the storage system 2 stores information (logical volume management table 200) managing the correspondence relationship between LDEV # and LUN, and uses the information to convert the information of a set of the S_ID and LUN designated in the I/O command from the server 3 to the LDEV #. The logical volume management table 200 (also referred to as “LDEV management table 200”) illustrated in FIG. 2 is a table for managing the correspondence relationship between LDEV # and LUN, and the same table is stored in the memories 24a and 24b of the controllers 21a and 21b, respectively. In fields S_ID 200-1 and LUN 200-2, S_ID of the server 3 and LUN mapped to the logical volume specified in LDEV #200-4 is stored. An MP #200-4 is a field for storing information related to ownership, and the ownership will be described in detail below.

In the storage system 2 according to Embodiment 1 of the present invention, a controller (21a or 21b) (or processor 23a or 23b) in charge of processing an access request to each logical volume is determined uniquely for each logical volume. The controller (21a or 21b) (or processor 23a or 23b) in charge of processing a request to a logical volume is called a “controller (or processor) having ownership”, and the information on the controller (or processor) having ownership is called “ownership information”, wherein in Embodiment 1 of the present invention, it is indicated that the ownership of the logical volume of the entry having 0 stored in the field of the MP #200-4 for storing ownership information is a volume owned by the MPU 23a of the controller 21a, and the ownership of the logical volume of the entry having 1 stored in the field of the MP #200-4 is a volume owned by the MPU 23b of the controller 21b. For example, the initial row (entry) 201 of FIG. 2 shows that the ownership of the logical volume having LDEV #1 is owned by the controller (or processor thereof) having 0 as the MP #200-4, that is, by the MPU 23a of the controller 21a. In Embodiment 1 of the present invention, each controller (21a or 21b) respectively has only one processor (23a or 23b) in the storage system 2, so that the description stating that “the controller 21a has ownership” and that “the processor (MPU) 23a has ownership” is substantially the same meaning.

We will describe an example assuming that an access request to a volume whose ownership is not owned by controller 21 arrives to controller 21 from the server 3. In the example of FIG. 2, the ownership of the logical volume having LDEV #1 is owned by the controller 21a. But when the controller 21b receives a read request from the server 3 to a logical volume having LDEV #1, since the controller 21b does not have ownership of the volume, the MPU 23b of the controller 21b transfers the read request to the MPU 23a of the controller 21a via a controller-to-controller connection path (I path) 27. The MPU 23a reads the read data from the HDD 22, and stores the read data to the internal cache memory (within memory 24a) of MPU 23a. Thereafter, the read data is returned to the server 3 via the controller-to-controller connection path (I path) 27 and the controller 21a. As described, when the controller 21 that does not have ownership of the volume receives the I/O request, transfer of the I/O request or the data accompanying the I/O request occurs between the controllers 21a and 21b, and the processing overhead increases. In order to prevent occurrence of such processing overhead, the present invention is arranged so that the storage system 2 provides ownership information of the respective volumes to the server 3. The function of the serve 3 will be described hereafter.

### (Outline of I/O Processing)

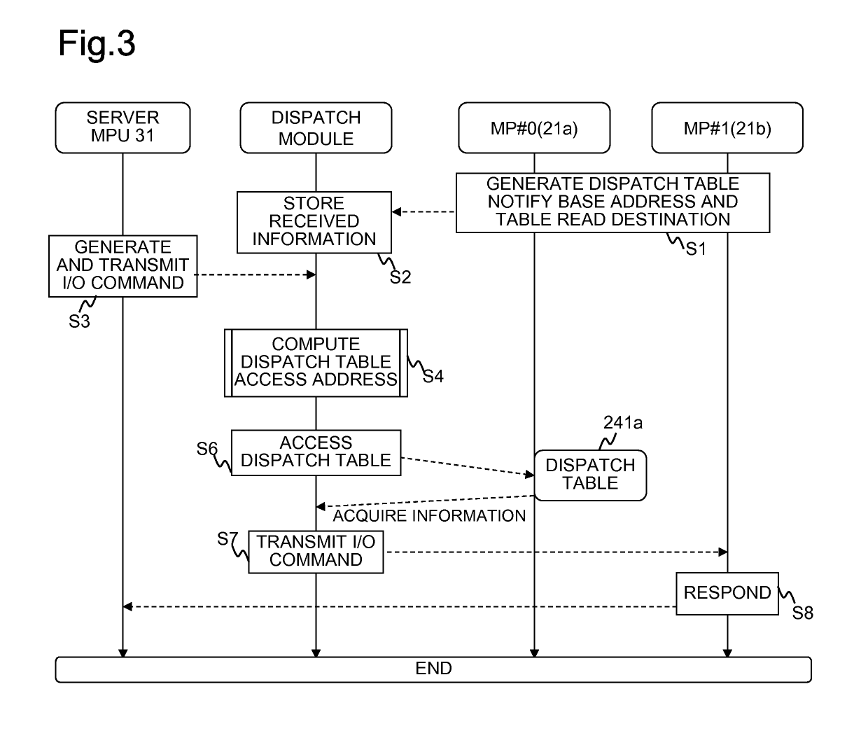

FIG. 3 illustrates an outline of a process performed when the server 3 transmits an I/O request to the storage system 2. At first, S1 is a process performed only at the time of initial setting after starting the computer system 1, wherein the storage controller 21a or 21b generates a dispatch table 241a or 241b, and notifies a read destination information of the dispatch table and a dispatch table base address information to the dispatch module 33 of the server 3. The dispatch table 241 is a table storing the ownership information, and the contents thereof will be described later. The generation processing of the dispatch table 241a (or 241b) in S1 is a process for allocating a storage area storing the dispatch table 241 in a memory and initializing the contents thereof (such as writing 0 to all areas of the table).

According further to Embodiment 1 of the present invention, the dispatch table 241a or 241b is stored in either one of the memories 24 of the controller 21a or 21b, and the read destination information in the dispatch table shows information on which controller's memory 24 should the dispatch module 33 access in order to access the dispatch table. The dispatch table base address information is information required for the dispatch module 33 to access the dispatch table 241, and the details thereof will follow. When the dispatch module 33 receives the read destination information, it stores the read destination information and the dispatch table base address information in the dispatch module 33 (S2). However, the present invention is effective also in a configuration where dispatch tables 241 storing identical information are stored in both memories 24a and 24b.

We will consider a case where a process for accessing a volume of the storage system 2 from the server 3 occurs after the processing of S2 has been completed. In that case, the MPU 31 generates an I/O command in S3. As mentioned earlier, the I/O command includes the S_ID which is the information related to the transmission source server 3 and the LUN of the volume.

When an I/O command is received from the MPU 31, the dispatch module 33 extracts the S_ID and the LUN in the I/O command, and uses the S_ID and the LUN to compute the access address of the dispatch table 241 (S4). The details of this process will be descried later. The dispatch module 33 is designed to enable reference of the data of the address by issuing an access request designating an address to the memory 241 of the storage system 2, and in S6, it accesses the dispatch table 241 of the controller 21 using the address computed in S4. At this time, it accesses either controller 21a or 21b based on the table read destination information stored in S2 (FIG. 3 illustrates a case where the dispatch table 241a is accessed). By accessing the dispatch table 241, it becomes possible to determine which controller 21a or 21b has ownership of the access target volume.

In S7, the I/O command (received in S3) is transferred to either the controller 21a or the controller 21b based on the information acquired in S6. In FIG. 3, an example where the controller 21b has ownership is illustrated. The controller 21 (21b) having received the I/O command performs processes within the controller 21, returns the response to the server 3 (the MPU 31 thereof) (S8), and ends the I/O processing. Thereafter, the processes of S3 through S8 are performed each time an I/O command is issued from the MPU 31.

### (Dispatch Table, Index Table)

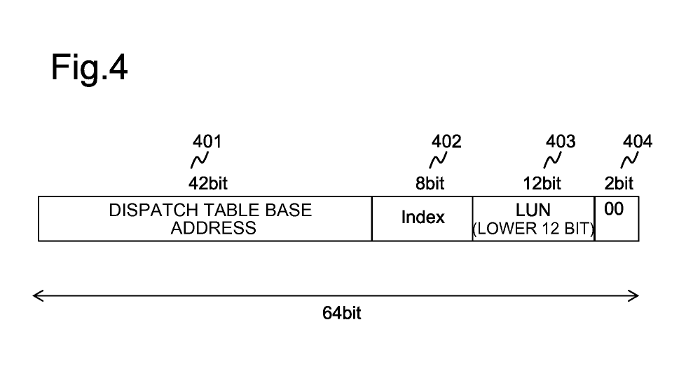

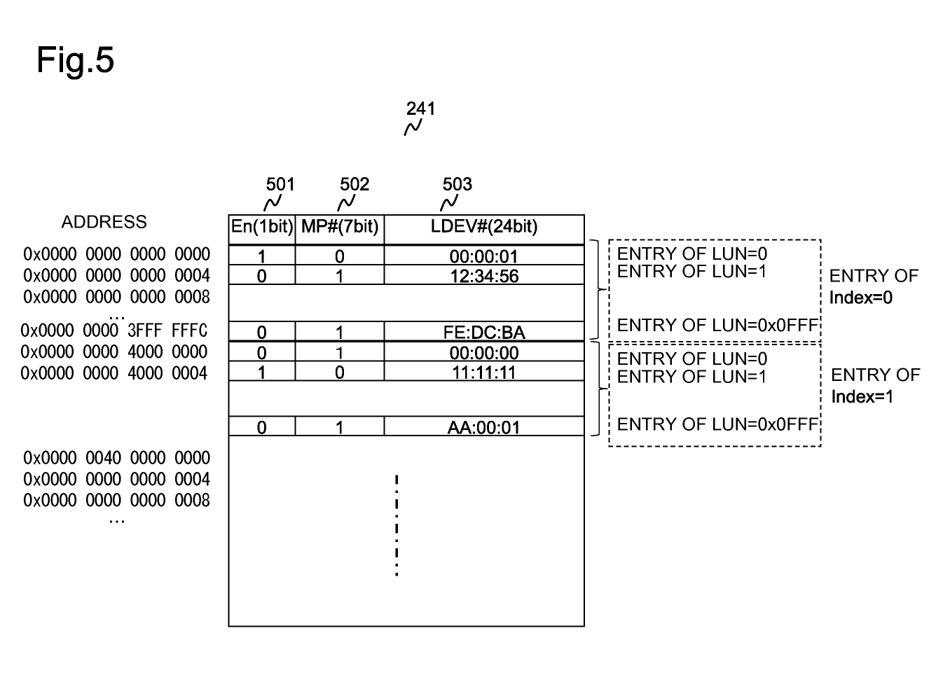

Next, an access address of the dispatch table 241 computed by the dispatch module 33 in S4 of FIG. 3 and the contents of the dispatch table 241 will be described with reference to FIGS. 4 and 5. A memory 24 of the storage controller 21 is a storage area having a 64-bit address space, and the dispatch table 241 is stored in a continuous area within the memory 24. FIG. 4 illustrates a format of the address information within the dispatch table 241 computed by the dispatch module 33. This address information is composed of a 42-bit dispatch table base address, an 8-bit index, a 12-bit LUN, and a 2-bit fixed value (where the value is 00). A dispatch table base address is information that the dispatch module 33 receives from the controller 21 in S2 of FIG. 3.

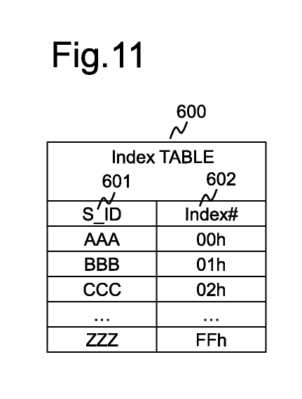

An index 402 is an 8-bit information that the storage system 2 derives based on the information of the server 3 (the S_ID) included in the I/O command, and the deriving method will be described later (hereafter, the information derived from the S_ID of the server 3 will be called an “index number”). The controllers 21a and 21b maintain and manage the information on the corresponding relationship between the S_ID and the index number as index table 600 as illustrated in FIG. 11 (the timing and method for generating the information will be described later). The LUN 403 is a logical unit number (LUN) of an access target LU (volume) included in the I/O command. In the process of S4 in FIG. 3, the dispatch module 33 of the server 3 generates an address based on the format of FIG. 4. For example, when the server 3 having a dispatch table base address 0 and an index number 0 wishes to acquire ownership information of LU where LUN=1, the dispatch module 33 generates an address 0x0000 0000 0000 0004, and acquires the ownership information by reading the content of the address 0x0000 0000 0000 0004 of the memory 24.

Next, the contents of the dispatch table 241 will be described with reference to FIG. 5. The respective entries (rows) of the dispatch table 241 are information storing the ownership information of each LU accessed by the server 3 and the LDEV # thereof, wherein each entry is composed of an enable bit (shown as “En” in the drawing) 501, an MP #502 storing the number of the controller 21 having ownership, and an LDEV #503 storing the LDEV # of the LU that the server 3 accesses. En 501 is 1-bit information, MP #502 is 7-bit information, and the LDEV # is 24-bit information, so that a single entry corresponds to a total of 32-bit (4 byte) information. The En 501 is information showing whether the entry is a valid entry or not, wherein if the value of the En 501 is 1, it means that the entry is valid, and if the value is 0, it means that the entry is invalid (that is, the LU corresponding to that entry is not defined in the storage system 2 at the current time point), wherein in that case, the information stored in the MP #502 and the LDEV #503 is invalid (unusable) information.

We will now describe the address of each entry of the dispatch table 241. Here, we will describe a case where the dispatch table base address is 0. As shown in FIG. 5, the 4-byte area starting from address 0 (0x0000 0000 0000 0000) of the dispatch table 241 stores the ownership information (and the LDEV #) for an LU having LUN 0 to which the server 3 (or the virtual computer operating in the server 3) having an index number 0 accesses. Subsequently, the address 0x0000 0000 0000 0004 to 0x0000 0000 0000 0007 and the address 0x0000 0000 0000 0008 to 0x0000 0000 0000 000F respectively store the ownership information of the LU having LUN 1 and the LU having LUN 2. The ownership information of all LUs accessed by the server 3 having the index number 0 are stored in the range from addresses 0x0000 0000 0000 0000 to 0x0000 0000 3FFF FFFF. Starting from address 0x0000 0000 4000 0000, the ownership information of the LU that the server 3 having index number 1 accesses are stored sequentially in order from LU where LUN=0.

### (Search Data Table)

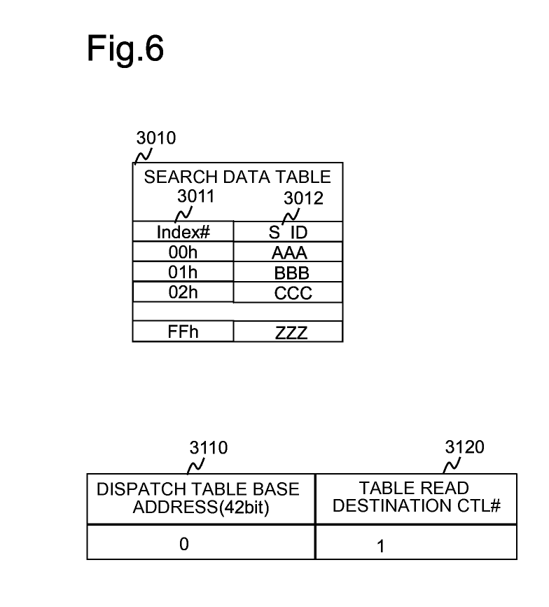

Next, the details of the process performed by the dispatch unit 35 of the server 3 (corresponding to S4 and S6 of FIG. 3) will be described, but prior thereto, the information that the dispatch unit 35 stores in its memory will be described with reference to FIG. 6. The information required for the dispatch unit 35 to perform the I/O dispatch processing are a search data table 3010, a dispatch table base address information 3110, and a dispatch table read destination CTL # information 3120. An index #3011 of the search data table 3010 stores an index number corresponding to the S_ID stored in the field of the S_ID 3012, and when an I/O command is received from the server 3, this search data table 3010 is used to derive the index number from the S_ID within the I/O command. However, the configuration of the search data table 3010 of FIG. 6 is merely an example, and other than the configuration illustrated in FIG. 6, the present invention is also effective, for example, when a table including only the field of the S_ID 3012, with the S_ID having index number 0, 1, 2, . . . stored sequentially from the head of the S_ID 3012 field, is used.

In the initial state, the row S_ID 3012 of the search data table 3012 has no value stored therein, and when the server 3 (or the virtual computer operating in the server 3) first issues an I/O command to the storage system 2, the storage system 2 stores information in the S_ID 3012 of the search data table 3010 at that time. This process will be described in detail later.

The dispatch table base address information 3110 is the information of the dispatch table base address used for computing the stored address of the dispatch table 241 described earlier. This information is transmitted from the storage system 2 to the dispatch unit 35 immediately after starting the computer system 1, so that the dispatch unit 35 having received this information stores this information in its own memory, and thereafter, uses this information for computing the access destination address of the dispatch table 241. The dispatch table read destination CTL # information 3120 is information for specifying which of the controllers 21a or 21b should be accessed when the dispatch unit 35 accesses the dispatch table 241. When the content of the dispatch table read destination CTL # information 3120 is “0”, the dispatch unit 35 accesses the memory 241a of the controller 21a, and when the content of the dispatch table read destination CTL # information 3120 is “1”, it accesses the memory 241b of the controller 21b. Similar to the dispatch table base address information 3110, the dispatch table read destination CTL # information 3120 is also the information transmitted from the storage system 2 to the dispatch unit 35 immediately after the computer system 1 is started.

### (Dispatch Processing)

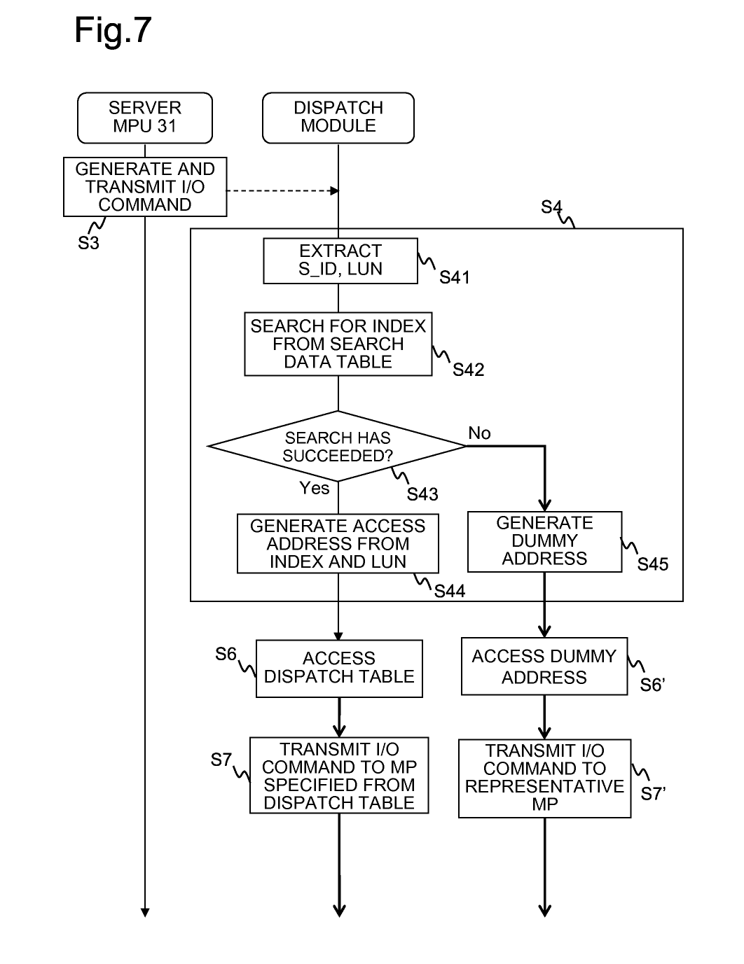

With reference to FIG. 7, the details of the processing (processing corresponding to S4 and S6 of FIG. 3) performed by the dispatch unit 35 of the server 3 will be described. When the dispatch unit 35 receives an I/O command from the MPU 31 via a port 36, the S_ID of the server 3 (or the virtual computer in the server 3) and the LUN of the access target LU, which are included in the I/O command, are extracted (S41). Next, the dispatch unit 35 performs a process to convert the extracted S_ID to the index number. At this time, a search data table 3010 managed in the dispatch unit 35 is used. The dispatch unit 35 refers to the S_ID 3012 of the search data table 3010 to search a row (entry) corresponding to the S_ID extracted in S41.

When an index #3011 of the row corresponding to the S_ID extracted in S41 is found (S43: Yes), the content of the index #3011 is used to create a dispatch table access address (S44), and using this created address, the dispatch table 241 is accessed to obtain information (information stored in MP #502 of FIG. 5) of the controller 21 to which the I/O request should be transmitted (S6). Then, the I/O command is transmitted to the controller 21 specified by the information acquired in S6 (S7).

The S_ID 3012 of the search data table 3010 does not have any value stored therein at first. When the server 3 (or the virtual computer operating in the server 3) first accesses the storage system 2, the MPU 23 of the storage system 2 determines the index number, and stores the S_ID of the server 3 (or the virtual computer in the server 3) to a row corresponding to the determined index number within the search data table 3010. Therefore, when the server 3 (or the virtual computer in the server 3) first issues an I/O request to the storage system 2, the search of the index number will fail because the S_ID information of the server 3 (or the virtual computer in the server 3) is not stored in the S_ID 3012 of the search data table 3010.

In the computer system 1 according to Embodiment 1 of the present invention, when the search of the index number fails, that is, if the information of the S_ID of the server 3 is not stored in the search data table 3010, an I/O command is transmitted to the MPU (hereinafter, this MPU is called a “representative MP”) of a specific controller 21 determined in advance. However, when the search of the index number fails (No in the determination of S43), the dispatch unit 35 generates a dummy address (S45), and designates the dummy address to access (for example, read) the memory 24 (S6′). A dummy address is an address that is unrelated to the address stored in the dispatch table 241. After S6′, the dispatch unit 35 transmits an I/O command to the representative MP (S7′). The reason for performing a process to access the memory 24 designating the dummy address will be described later.

### (Update of Dispatch Table)

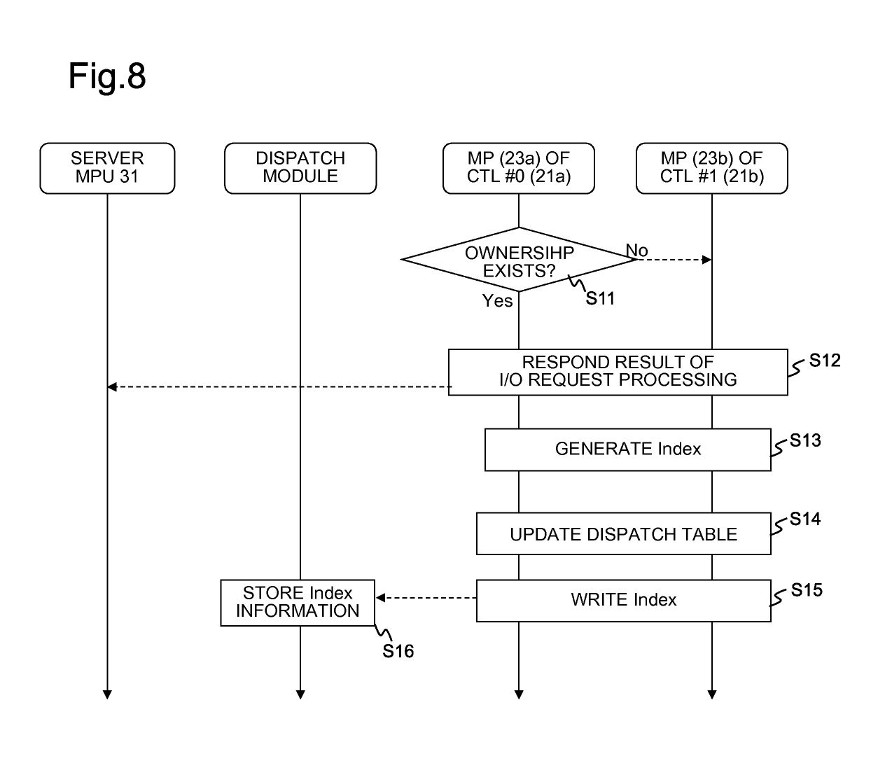

Next, we will describe with reference to FIG. 8 the flow of processing in the storage system 2 having received the I/O command transmitted to the representative MP when the search of the index number has failed (No in the determination of S43). When the representative MP (here, we will describe an example where the MPU 23a of the controller 21a is a representative MP) receives an I/O command, the controller 21a refers to the S_ID and the LUN included in the I/O command and the LDEV management table 200, and determines whether it has the ownership of the access target LU (S11). If it has ownership, the subsequent processes are executed by the controller 21a, and if it does not have ownership, it transfers the I/O command to the controller 21b. The subsequent processes are performed by either one of the controllers 21a or 21b. And even if it is executed in controller 21a or controller 21b, the processes performed in the controllers 21a or 21b are similar. Therefore, it will be described here that “the controller 21” performs the processes.

In S12, the controller 21 processes the received I/O request, and returns the processing result to the server 3.

In S13, the controller 21 performs a process of mapping the S_ID contained in the I/O command processed prior to S12 to the index number. During mapping, the controller 21 refers to the index table 600, searches for index numbers that have not yet been mapped to any S_ID, and selects one of the index numbers. Then, the S_ID included in the I/O command is registered in the field of the S_ID 601 of the row corresponding to the selected index number (index #602).

In S14, the controller 21 updates the dispatch table 241. The entries in which the S_ID (200-1) matches the S_ID included in the current I/O command out of the information in the LDEV management table 200 are selected, and the information in the selected entries are registered in the dispatch table 241.

Regarding the method for registering information to the dispatch table 241, we will describe an example where the S_ID included in the current I/O command is AAA and that the information illustrated in FIG. 2 is stored in the LDEV management table 200. In this case, entries having LDEV # (200-3) 1, 2 and 3 (rows 201 through 203 in FIG. 2) are selected from the LDEV management table 200, and the information in these three entries are registered to the dispatch table 241.

Since respective information are stored in the dispatch table 241 based on the rule described with reference to FIG. 5, it is possible to determine which position in the dispatch table 241 the ownership (information stored in the MP #502) and the LDEV # (information stored in the LDEV #503) should be registered based on the information on the index number and the LUN. If the S_ID (AAA) included in the current I/O command is mapped to the index number 01h, it can be recognized that the information of the LDEV having an index number 1 and a LUN 0 is stored in a 4-byte area starting from the address 0x0000 0000 4000 0000 of the dispatch table 241 of FIG. 5. Therefore, the MP #200-4 (“0” in the example of FIG. 2) and the LDEV #200-3 (“1” in the example of FIG. 2) in the row 201 of the LDEV management table 200 are stored in the respective entries of MP #502 and the LDEV #503 in the address 0x0000 0000 4000 0000 of the dispatch table 241, and “1” is stored in the En 501. Similarly, the information in the rows 202 and 203 of FIG. 2 are stored in the dispatch table 241 (addresses 0x0000 0000 4000 0004, 0x0000 0000 4000 0008), and the update of the dispatch table 241 is completed.

Lastly, in S15, the information of the index number mapped to the S_ID is written into the search data table 3010 of the dispatch module 33. The processes of S14 and S15 correspond to the processes of S1 and S2 of FIG. 3.

### (Processing During Generation of LU)

Since the dispatch table 241 is the table storing information related to ownership, LU and LDEV, when an LU is generated or when change of ownership occurs, registration or update of the information occurs. Here, the flow for registering information to the dispatch table 421 will be described taking a generation of LU as an example.

When the administrator of the computer system 1 defines an LU using the management terminal 4 or the like, the administrator designates the information of the server 3 (S_ID), the LDEV # of the LDEV which should be mapped to the LU to be defined, and the LUN of the LU. When the management terminal 4 receives the designation of these information, it instructs the storage controller 21 (21a or 21b) to generate an LU. Upon receiving the instruction, the controller 21 registers the designated information to the fields of the S_ID 200-1, the LUN 200-2 and the LDEV #200-3 of the LDEV management table 200 within the memories 24a and 24b. At that time, the ownership information of the volume is automatically determined by the controller 21, and registered in the MP #200-4. As another embodiment, it is possible to enable the administrator to designate the controller 21 (MPU 23) having ownership.

After registering the information to the LDEV management table 200 through LU definition operation, the controller 21 updates the dispatch table 241. Out of the information used for defining the LU (the S_ID, the LUN, the LDEV #, and the ownership information), the S_ID is converted into an index number using the index table 600. As described above, using the information on the index number and the LUN, it becomes possible to determine the position (address) within the dispatch table 241 to which the ownership (information stored in MP #502) and the LDEV # (information stored in LDEV #503) should be registered. For example, if the result of converting the S_ID into the index number results in the index number being 0 and the LUN of the defined LU being 1, it is determined that the information of address 0x0000 0000 0000 0004 in the dispatch table 241 of FIG. 5 should be updated. Therefore, the ownership information and the LDEV # mapped to the currently defined LU are stored in the MP #502 and the LDEV #503 of the entry of the address 0x0000 0000 0000 0004 of the dispatch table 241, and “1” is stored in the En 501. If the index number corresponding to the S_ID of the server 3 (or the virtual computer operating in the server 3) is not determined, information cannot be registered to the dispatch table 241, so in that case, the controller 21 will not perform update of the dispatch table 241.

### (Multiprocessing of Command)

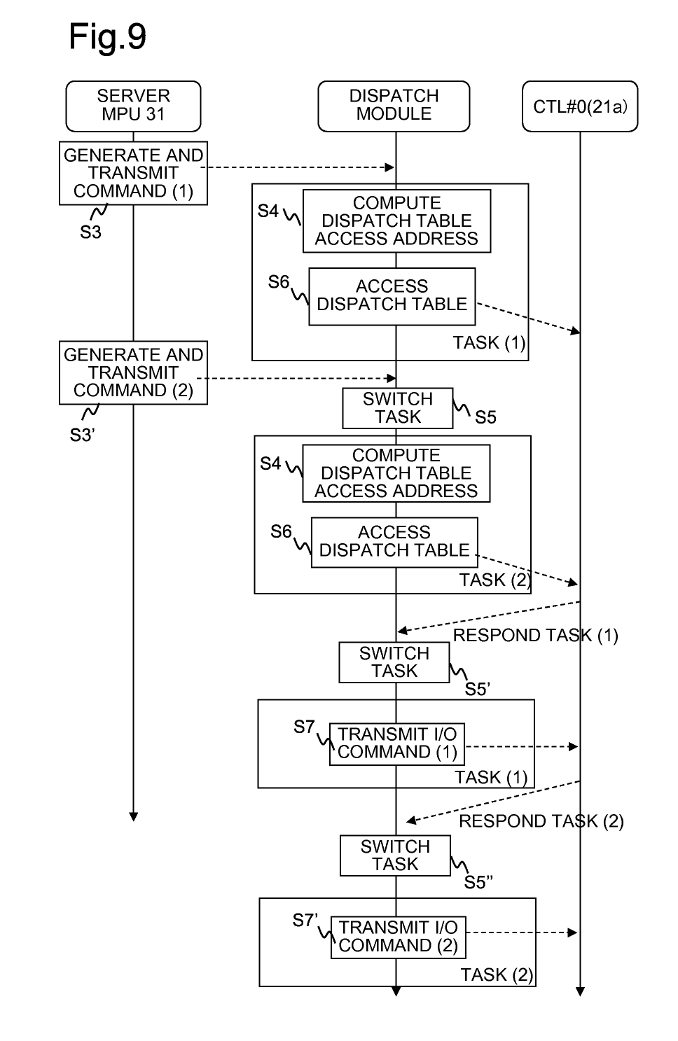

The dispatch module 33 according to Embodiment 1 of the present invention is capable of receiving multiple I/O commands at the same time and dispatching them to the controller 21a or the controller 21b. In other words, the module can receive a first command from the MPU 31, and while performing a determination processing of the transmission destination of the first command, the module can receive a second command from the MPU 31. The flow of the processing in this case will be described with reference to FIG. 9.

When the MPU 31 generates an I/O command (1) and transmits it to the dispatch module (FIG. 9: S3), the dispatch unit 35 performs a process to determine the transmission destination of the I/O command (1), that is, the process of S4 in FIG. 3 (or S41 through S45 of FIG. 7) and the process of S6 (access to the dispatch table 241). In the present example, the process for determining the transmission destination of the I/O command (1) is called a “task (1)”. During processing of this task (1), when the MPU 31 generates an I/O command (2) and transmits it to the dispatch module (FIG. 9: S3′), the dispatch unit 35 temporarily discontinues task (1) (switches tasks) (FIG. 9: S5), and starts a process to determine the transmission destination of the I/O command (2) (this process is called “task (2)”). Similar to task (1), task (2) also executes an access processing to the dispatch table 241. In the example illustrated in FIG. 9, the access request to the dispatch table 241 via task (2) is issued before the response to the access request by the task (1) to the dispatch table 241 is returned to the dispatch module 33. When the dispatch module 33 accesses the memory 24 existing outside the server 3 (in the storage system 2), the response time will become longer compared to the case where the memory within the dispatch module 33 is accessed, so that if the task (2) awaits completion of the access request by task (1) to the dispatch table 241, the system performance will be deteriorated. Therefore, access by task (2) to the dispatch table 241 is enabled without waiting for completion of the access request by task (1) to the dispatch table 241.

When the response to the access request by task (1) to the dispatch table 241 is returned from the controller 21 to the dispatch module 33, the dispatch unit 35 switches tasks again (S5′), returns to execution of the task (1), and performs a transmission processing of the I/O command (1) (FIG. 9: S7). Thereafter, when the response to the access request by task (2) to the dispatch table 241 is returned from the controller 21 to the dispatch module 33, the dispatch unit 35 switches tasks again (FIG. 9: S5″), moves on to execution of task (2), and performs the transmission processing (FIG. 9: S7′) of I/O command (2).

Now, during the calculation of the dispatch table access address (S4) performed in task (1) and task (2), as described in FIG. 7, there may be a case where the index number search fails and access address to the dispatch table 241 cannot be generated. In that case, as described in FIG. 7, a dummy address is designated and a process to access the memory 24 is performed. When the search of the index number fails, there is no other choice than to transmit an I/O command to the representative MP, so that it is basically not necessary to access the memory 24, but by reasons mentioned below, the designated dummy address in the memory 24 is accessed.

For example, we will consider a case where the search of the index number according to task (2) in FIG. 7 has failed. In that case, if an arrangement is adopted to directly transmit the I/O command to the representative MP (without accessing the memory 24) at the point of time when the search of the index number fails, the access to the dispatch table 241 by task (1) takes up much time, and the task (2) may transmit the I/O command to the representative MP before the response to task (1) is returned from the controller 21 to the dispatch module 33. Accordingly, the order of processing of the I/O command (1) and the I/O command (2) will be switched unfavorably, so that in Embodiment 1 of the present invention, the dispatch unit 35 performs a process to access the memory 24 even when the search of the index number has failed. According to the computer system 1 of the present invention, when the dispatch module 33 issues multiple access requests to the memory 24, a response corresponding to each access request is returned in the issuing order of the access request (so that the order is ensured).

However, having the dispatch module access a dummy address in the memory 24 is only one of the methods for ensuring the order of the I/O commands, and it is possible to adopt other methods. For example, even when the issue destination (such as the representative MP) of the I/O command by the task (2) is determined, it is possible to perform control to have the dispatch module 33 wait (wait before executing S6 in FIG. 7) before issuing the I/O command by task (2) until the I/O command issue destination of task (1) is determined, or until the task (1) issues an I/O command to the storage system 2.

### (Processing During Occurrence of Failure)

Next, we will describe a process to be performed when failure occurs in the storage system 2 according to Embodiment 1 of the present invention, and one of the multiple controllers 21 stop operating. When one controller 21 stops to operate, and if the stopped controller 21 stores the dispatch table 241, the server 3 will not be able to access the dispatch table 241 thereafter, so that there is a need to move (recreate) the dispatch table 241 in another controller 21 and to have the dispatch module change the information on the access destination controller 21 upon accessing the dispatch table 241. Further, it is necessary to change the ownership of the volume to which the stopped controller 21 had the ownership.

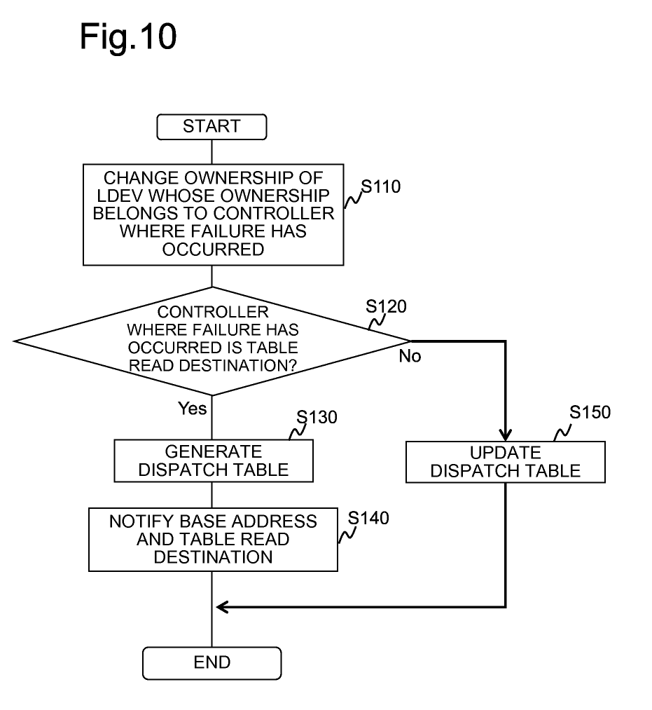

With reference to FIG. 10, we will describe the process performed by the storage system 2 when one of the multiple controllers 21 stop operating. When any one of the controllers 21 within the storage system 2 detects that a different controller 21 has stopped, the present processing is started by the controller 21 having detected the stoppage. Hereafter, we will describe a case where failure has occurred in the controller 21a and the controller 21a has stopped, and the stopping of the controller 21a is detected by the controller 21b. At first, regarding the volume whose ownership has belonged to the controller 21 (controller 21a) having stopped by failure, the ownership thereof is changed to a different controller 21 (controller 21b) (S110). Specifically, the ownership information managed by the LDEV management table 200 is changed. The process will be explained with reference to FIG. 2. Out of the volumes managed in the LDEV management table 200, the ownerships of the volume whose MP #200-4 is “0” (representing the controller 21a) are all changed to a different controller (controller 21b). That is, regarding the entries having “0” stored in the MP #200-4, the contents of the MP #200-4 are changed to “1”.

Thereafter, in S120, whether the stopped controller 21a has included a dispatch table 241 or not is determined. If the result is yes, the controller 21b refers to the LDEV management table 200 and the index table 600 to create a dispatch table 241b (S130), transmits information on the dispatch table base address of the dispatch table 241b and the table read destination controller (controller 21b) with respect to the server 3 (the dispatch module 33 thereof) (S140), and ends the process. When information is transmitted to the server 3 by the process of S140, the setting of the server 3 is changed so as to perform access to the dispatch table 241b within the controller 21b thereafter.

On the other hand, when the determination in S120 is No, it means that the controller 21b has been managing the dispatch table 241b, and in that case, it is not necessary to change the access destination of the dispatch table 241 in the server 3. However, the dispatch table 241 includes the ownership information, and these information must be updated, so that based on the information in the LDEV management table 200 and the index table 600, the dispatch table 241b is updated (S150), and the process is ended.

### Embodiment 2

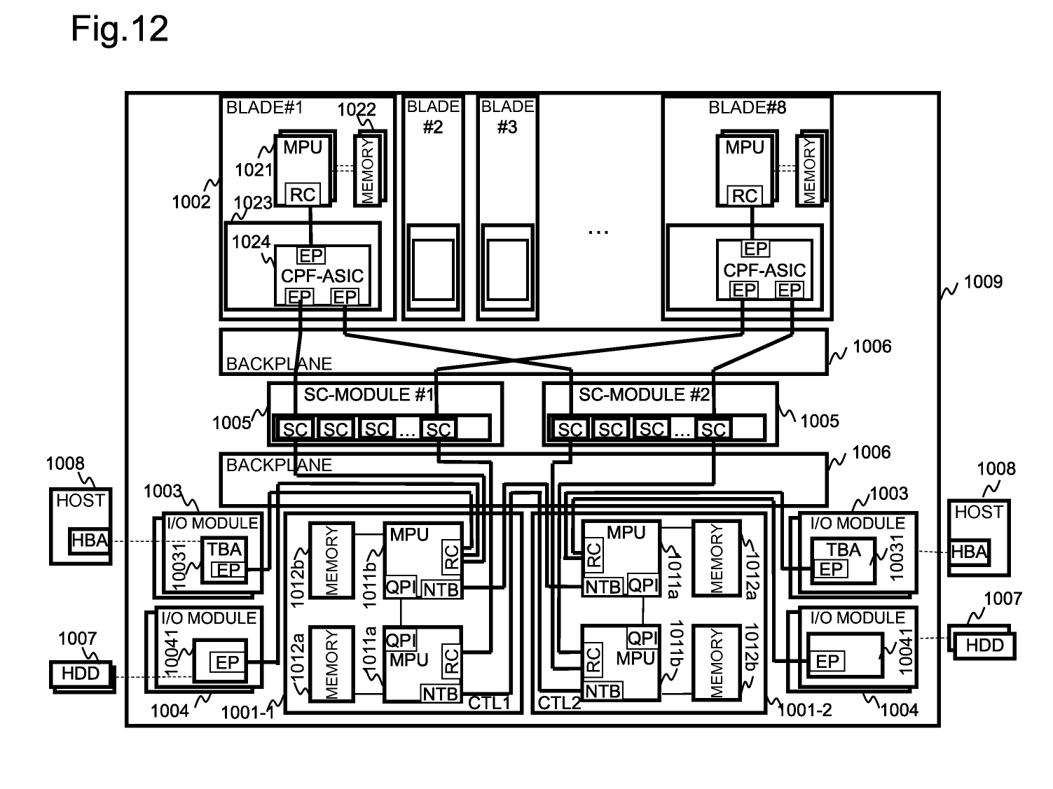

Next, the configuration of a computer system 1000 according to Embodiment 2 of the present invention will be described. FIG. 12 illustrates major components of a computer system 1000 according to Embodiment 2 of the present invention, and the connection relationship thereof. The major components of the computer system 1000 include a storage controller module 1001 (sometimes abbreviated as “controller 1001”), a server blade (abbreviated as “blade” in the drawing) 1002, a host I/F module 1003, a disk I/F module 1004, an SC module 1005, and an HDD 1007. Sometimes, the host I/F module 1003 and the disk I/F module 1004 are collectively called the “I/O module”.

The set of controller 1001 and the disk I/F module 1004 has a similar function as the storage controller 21 of the storage system 2 according to Embodiment 1. Further, the server blade 1002 has a similar function as the server 3 in Embodiment 1.

Moreover, it is possible to have multiple storage controller modules 1001, server blades 1002, host I/F modules 1003, disk I/F modules 1004, and SC modules 1005 disposed within the computer system 1000. In the following description, an example is illustrated where there are two storage controller modules 1001, and if it is necessary to distinguish the two storage controller modules 1001, they are each referred to as “storage controller module 1001-1” (or “controller 1001-1”) and “storage controller module 1001-2 (or “controller 1001-2”). The illustrated configuration includes eight server blades 1002, and if it is necessary to distinguish the multiple server blades 1002, they are each referred to as server blade 1002-1, 1002-2, . . . and 1002-8.

Communication between the controller 1000 and the server blade 1002 and between the controller 1000 and the I/O module are performed according to PCI (Peripheral Component Interconnect) Express (hereinafter abbreviated as “PCIe”) standard, which is one type of I/O serial interface (a type of expansion bus). When the controller 1000, the server blade 1002 and the I/O module are connected to a backplane 1006, the controller 1000 and the server blade 1002, and the controller 1000 and the I/O module (1003, 1004), are connected via a communication line according to PCIe standard.

The controller 1001 provides a logical unit (LU) to the server blade 1002, and processes the I/O request from the server blade 1002. The controllers 1001-1 and 1001-2 have identical configurations, and each controller has an MPU 1011a, an MPU 1011b, a storage memory 1012a, and a storage memory 1012b. The MPUs 1011a and 1011b within the controller 1001 are interconnected via a QPI (Quick Path Interconnect) link, which is a chip-to-chip connection technique provided by Intel, and the MPUs 1011a of controllers 1001-1 and 1001-2 and the MPUs 1011b of controllers 1001-1 and 1001-2 are mutually connected via an NTB (Non-Transparent Bridge). Although not shown in the drawing, the respective controllers 1001 have an NIC for connecting to the LAN, similar to the storage controller 21 of Embodiment 1, so that it is in a state capable of communicating with a management terminal (not shown) via the LAN.

The host I/F module 1003 is a module having an interface for connecting a host 1008 existing outside the computer system 1000 to the controller 1001, and has a TBA (Target Bus Adapter) for connecting to an HBA (Host Bus Adapter) that the host 1008 has.

The disk I/F module 1004 is a module having an SAS controller 10041 for connecting multiple hard disks (HDDs) 1007 to the controller 1001, wherein the controller 1001 stores write data from the server blade 1002 or the host 1008 to multiple HDDs 1007 connected to the disk I/F module 1004. That is, the set of the controller 1001, the host I/F module 1003, the disk I/F module 1004 and the multiple HDDs 1007 correspond to the storage system 2 according to Embodiment 1. The HDD 1007 can adopt a semiconductor storage device such as an SSD, other than a magnetic disk such as a hard disk.

The server blade 1002 has one or more MPUs 1021 and a memory 1022, and has a mezzanine card 1023 to which an ASIC 1024 is loaded. The ASIC 1024 corresponds to the dispatch module loaded in the server 3 according to Embodiment 1, and the details thereof will be described later. Further, the MPU 1021 can be a so-called multicore processor having multiple processor cores.

The SC module 1005 is a module having a signal conditioner (SC) which is a repeater of a transmission signal, provided to prevent deterioration of signals transmitted between the controller 1001 and the server blade 1002.

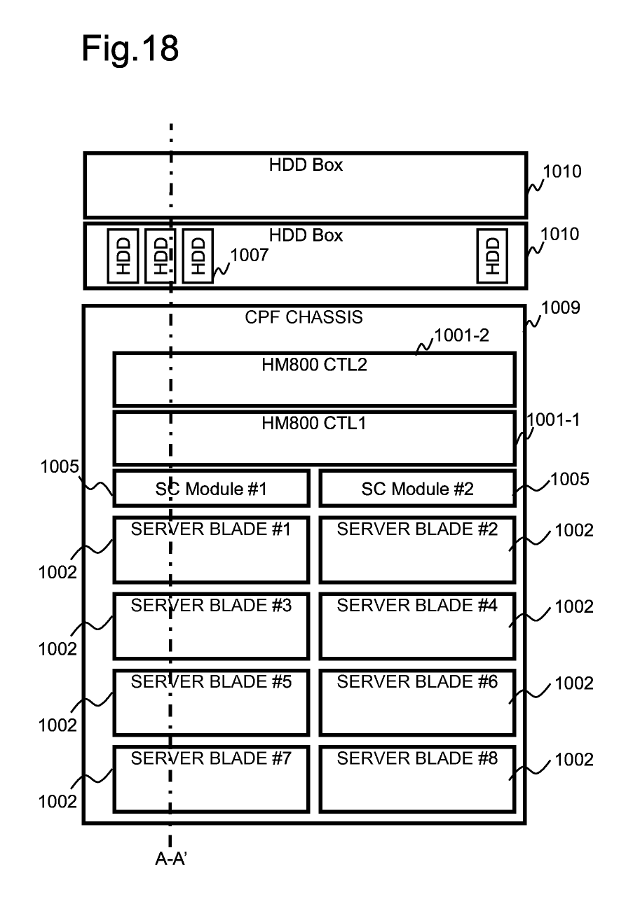

Next, with reference to FIGS. 18 through 20, one implementation example for mounting the various components described in FIG. 12 will be illustrated. FIG. 18 illustrates an example of a front side view where the computer system 1000 is mounted on a rack, such as a 19-inch rack. In the respective components constituting the computer system 1000 in Embodiment 2, the components excluding the HDD 1007 is stored in a single chassis called a CPF chassis 1009. The HDD 1007 is stored in a chassis called an HDD box 1010. The CPF chassis 1009 and the HDD box 1010 are loaded in a rack such as an 19-inch rack, and the HDD 1007 (and the HDD box 1010) will be added along with the increase of data quantity handled in the computer system 1000, so that as shown in FIG. 18, a CPF chassis 1009 is placed on the lower level of the rack, and the HDD box 1010 will be placed above the CPF chassis 1009.

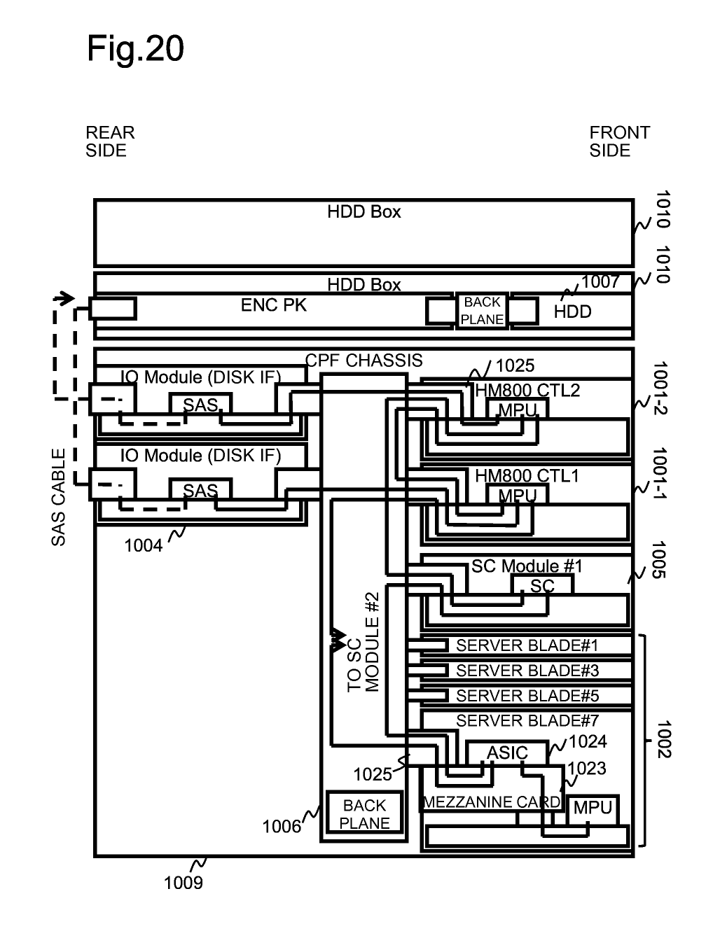

The components loaded in the CPF chassis 1009 are interconnected by being connected to the backplane 1006 within the CPF chassis 1009. FIG. 20 illustrates a cross-sectional view taken along line A-A′ shown in FIG. 18. As shown in FIG. 20, the controller 1001, the SC module 1005 and the server blade 1002 are loaded on the front side of the CPF chassis 1009, and a connector placed on the rear side of the controller 1001 and the server blade 1002 are connected to the backplane 1006. The I/O module (disk I/F module) 1004 is loaded on the rear side of the CPF chassis 1009, and also connected to the backplane 1006 similar to the controller 1001. The backplane 1006 is a circuit board having a connector for interconnecting various components of the computer system 1000 such as the server blade 1002 and the controller 1001, and enables to interconnect the respective components by having the connector (the box 1025 illustrated in FIG. 20 existing between the controller 1001 or the server blade 1002 and the backplane 1006 is the connector) of the controller 1001, the server blade 1002, the I/O modules 1003 and 1004 and the SC module 1005 connect to the connector of the backplane 1006.

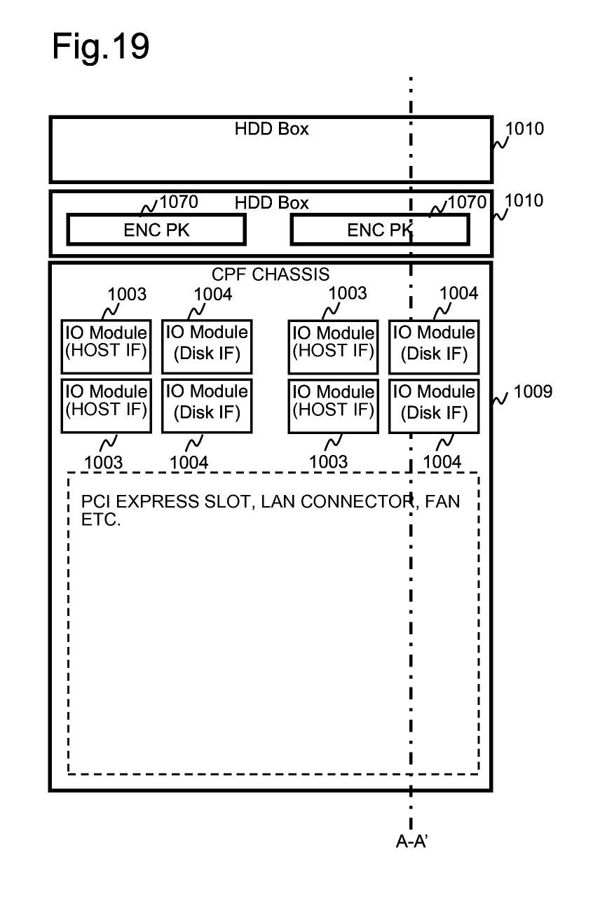

Although not shown in FIG. 20, similar to the disk I/F module 1004, the I/O module (host I/F module) 1003 is loaded on the rear side of the CPF chassis 1009, and connected to the backplane 1006. FIG. 19 illustrates an example of a rear side view of the computer system 1000, and as shown, the host I/F module 1003 and the disk I/F module 1004 are both loaded on the rear side of the CPF chassis 1009. Fans, LAN connectors and the like are loaded to the space below the I/O modules 1003 and 1004, but they are not necessary components for illustrating the present invention, so that the descriptions thereof are omitted.

According to this configuration, the server blade 1002 and the controller 1001 are connected via a communication line compliant to PCIe standard with the SC module 1005 intervened, and the I/O modules 1003 and 1004 and the controller 1001 is also connected via a communication line compliant to PCIe standard. Moreover, the controllers 1001-1 and 1001-2 are also interconnected via NTB.

The HDD box 1010 arranged above the CPF chassis 1009 is connected to the I/O module 1004, and the connection is realized via a SAS cable arranged on the rear side of the chassis.

As mentioned earlier, the HDD box 1010 is arranged above the CPF chassis 1009. Considering maintainability, the HDD box, the controller 1001 and the I/O module 1004 should preferably be arranged at approximate positions, so that the controller 1001 is arranged on the upper area within the CPF chassis 1009, and the server blade 1002 is arranged on the lower area of the CPF chassis 1009. However, according to such arrangement, the communication line connecting the server blade 1002 placed on the lowest area and the controller 1001 placed on the highest area becomes long, so that the SC module 1005 preventing deterioration of signals flowing therebetween is inserted between the server blade 1002 and the controller 1001.

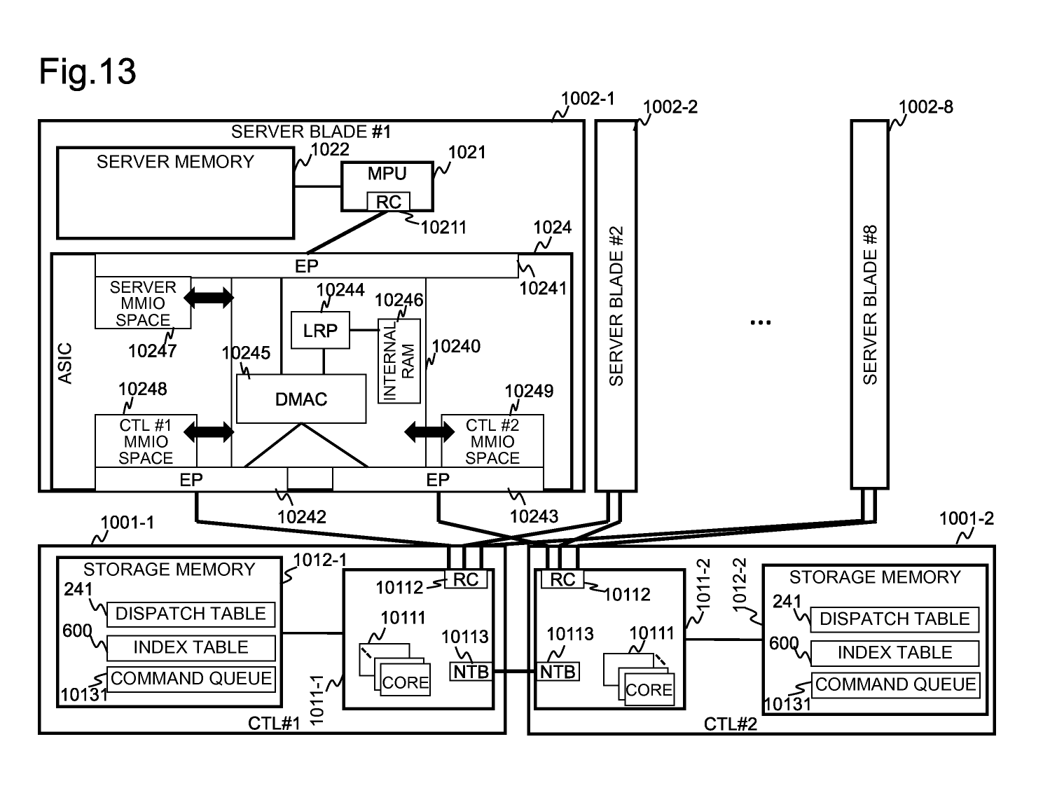

Thereafter, the internal configuration of the controller 1001 and the server blade 1002 will be described in further detail with reference to FIG. 13.

The server blade 1002 has an ASIC 1024 which is a device for dispatching the I/O request (read, write command) to either the controller 1001-1 or 1001-2. The communication between the MPU 1021 and the ASIC 1024 of the server blade 1002 utilizes PCIe, similar to the communication method between the controller 1000 and the server blade 1002. A root complex (abbreviated as “RC” in the drawing) 10211 for connecting the MPU 1021 and an external device is built into the MPU 1021 of the server blade 1002, and an endpoint (abbreviated as “EP” in the drawing) 10241 which is an end device of a PCIe tree connected to the root complex 10211 is built into the ASIC 1024.

Similar to the server blade 1002, the controller 1001 uses PCIe as the communication standard between the MPU 1011 within the controller 1001 and devices such as the I/O module. The MPU 1011 has a root complex 10112, and each I/O module (1003, 1004) has an endpoint connected to the root complex 10112 built therein. Further, the ASIC 1024 has two endpoints (10242, 10243) in addition to the endpoint 10241 described earlier. These two endpoints (10242, 10243) differ from the aforementioned endpoint 10241 in that they are connected to a rood complex 10112 of the MPU 1011 within the storage controller 1011.

As illustrated in the configuration example of FIG. 13, one (such as endpoint 10242) of the two endpoints (10242, 10243) is connected to a root complex 10112 of the MPU 1011 within the storage controller 1011-1, and the other endpoint (such as the endpoint 10243) is connected to the root complex 10112 of the MPU 1011 within the storage controller 1011-2. That is, the PCIe domain including the root complex 10211 and the endpoint 10241 and the PCIe domain including the root complex 10112 within the controller 1001-1 and the endpoint 10242 are different domains. Further, the domain including the root complex 10112 within the controller 1001-2 and the endpoint 10243 is also a PCIe domain that differs from other domains.

The ASIC 1024 includes endpoints 10241, 10242 and 10243 described earlier and an LRP 10244 which is a processor executing a dispatch processing mentioned later, a DMA controller (DMAC) 10245 executing a data transfer processing between the server blade 1002 and the storage controller 1001, and an internal RAM 10246. During data transfer (read processing or write processing) between the server blade 1002 and the controller 1001, a function block 10240 composed of an LRP 10244, a DMAC 10245 and an internal RAM 10246 operates as a master device of PCIe, so that this function block 10240 is called a PCIe master block 10240. The respective endpoints 10241, 10242 and 10243 belong to different PCIe domains, so that the MPU 1021 of the server blade 1021 cannot directly access the controller 1001 (for example, the storage memory 1012 thereof). It is also not possible for the MPU 1011 of the controller 1001 to access the server memory 1022 of the server blade 1021. On the other hand, the components (such as the LRP 10244 and the DMAC 10245) of the PCIe master block 10240 is capable of accessing (reading, writing) both the storage memory 1012 of the controller 1001 and the server memory 1022 of the server blade 1021.

Further according to PCIe, the resistor and the like of the I/O device can be mapped to the memory space, wherein the memory space having the resistor and the like mapped thereto is called an MMIO (Memory Mapped Input/Output) space. The ASIC 1024 includes a server MMIO space 10247 which is an MMIO space capable of being accessed by the MPU 1021 of the server blade 1002, an MMIO space for CTL1 10248 which is an MMIO space capable of being accessed by the MPU 1011 (processor core 10111) of the controller 1001-1 (CTL1), and an MMIO space for CTL2 10249 which is an MMIO space capable of being accessed by the MPU 1011 (processor core 10111) of the controller 1001-2 (CTL2). According to this arrangement, the MPU 1011 (the processor core 10111) and the MPU 1021 perform read/write of control information to the MMIO space, by which they can instruct data transfer and the like to the LRP 10244 or the DMAC 1024.

The PCIe domain including the root complex 10112 and the endpoint 10242 within the controller 1001-1 and the domain including the root complex 10112 and the endpoint 10243 within the controller 1001-2 are different PCIe domains, but since the MPUs 1011a of controllers 1001-1 and 1001-2 are mutually connected via an NTB and the MPUs 1011b of controllers 1001-1 and 1001-2 are mutually connected via an NTB, data can be written (transferred) to the storage memory (1012a, 1012b) of the controller 1001-2 from the controller 1001-1 (the MPU 1011 thereof). On the other hand, it is also possible to have data written (transferred) from the controller 1001-2 (the MPU 1011 thereof) to the storage memory (1012a, 1012b) of the controller 1001-1.

As shown in FIG. 12, each controller 1001 includes two MPUs 1011 (MPUs 1011a and 1011b), and each of the MPU 1011a and 1011b includes, for example, four processor cores 10111. Each processor core 10111 processes read/write command requests to a volume arriving from the server blade 1002. Each MPU 1011a and 1011b has a storage memory 1012a or 1012b connected thereto. The storage memories 1012a and 1012b are respectively physically independent, but as mentioned earlier, the MPU 1011a and 1011b are interconnected via a QPI link, so that the MPUs 1011a and 1011b (and the processor cores 10111 within the MPUs 1011a and 1011b) can access both the storage memories 1012a and 1012b (accessible as a single memory space).

Therefore, as shown in FIG. 13, it can be assumed that the controller 1001-1 substantially has a single MPU 1011-1 and a single storage memory 1012-1 formed therein. Similarly, it can be assumed that the controller 1001-2 substantially has a single MPU 1011-2 and a single storage memory 1012-2 formed therein. Further, the endpoint 10242 on the ASIC 1024 can be connected to the root complex 10112 of any of the two MPUs (1011a, 1011b) on the controller 1001-1, and similarly, the endpoint 10243 can be connected to the root complex 10112 of any of the two MPUs (1011a, 1011b) on the controller 1011-2.

In the following description, the multiple MPUs 1011a and 1011b and the storage memories 1012a and 1012b within the controller 1001-1 are not distinguished, and the MPU within the controller 1001-1 is referred to as “MPU 1011-1” and the storage memory is referred to as “storage memory 1012-1”. Similarly, the MPU within the controller 1001-2 is referred to as “MPU 1011-2” and the storage memory is referred to as “storage memory 1012-2”. As mentioned earlier, since the MPU 1011a and 1011b respectively have four processor cores 10111, the MPUs 1011-1 and 1011-2 can be considered as MPUs respectively having eight processor cores.

### (LDEV Management Table)

Next, we will describe the management information that the storage controller 1001 has according to Embodiment 2 of the present invention. At first, we will describe the management information of the logical volume (LU) that the storage controller 1001 provides to the server blade 1002 or the host 1008.

The controller 1001 according to Embodiment 2 also has the same LDEV management table 200 as the LDEV management table 200 that the controller 21 of Embodiment 1 comprises. However, according to the LDEV management table 200 of Embodiment 2, the contents stored in the MP #200-4 somewhat differs from the LDEV management table 200 of Embodiment 1.

In the controller 1001 of Embodiment 2, eight processor cores exist with respect to a single controller 1001, so that a total of 16 processor cores exist in the controller 1001-1 and controller 1001-2. In the following description, the respective processor cores in Embodiment 2 have assigned thereto an identification number of 0x00 through 0x0F, wherein the controller 1001-1 has processor cores having identification numbers 0x00 through 0x07, and the controller 1001-2 has processor cores having identification numbers 0x08 through 0x0F. Further, the processor core having an identification number N (wherein N is a value between 0x00 and 0x0F) is sometimes referred to as “core N”.

Since according to Embodiment 1, a single MPU is loaded to each controller 21a and 21b, so that either 0 or 1 is stored in the field (field storing information of the processor having ownership of LU) of MP #200-4 of the LDEV management table 200. On the other hand, the controller 1001 according to Embodiment 2 has 16 processor cores, one of which having the ownership of the respective LUs. Therefore, an identification number (value between 0x00 and 0x0F) of the processor core having ownership is stored in the field of the MP #200-4 of the LDEV management table 200 according to Embodiment 2.

### (Command Queue)

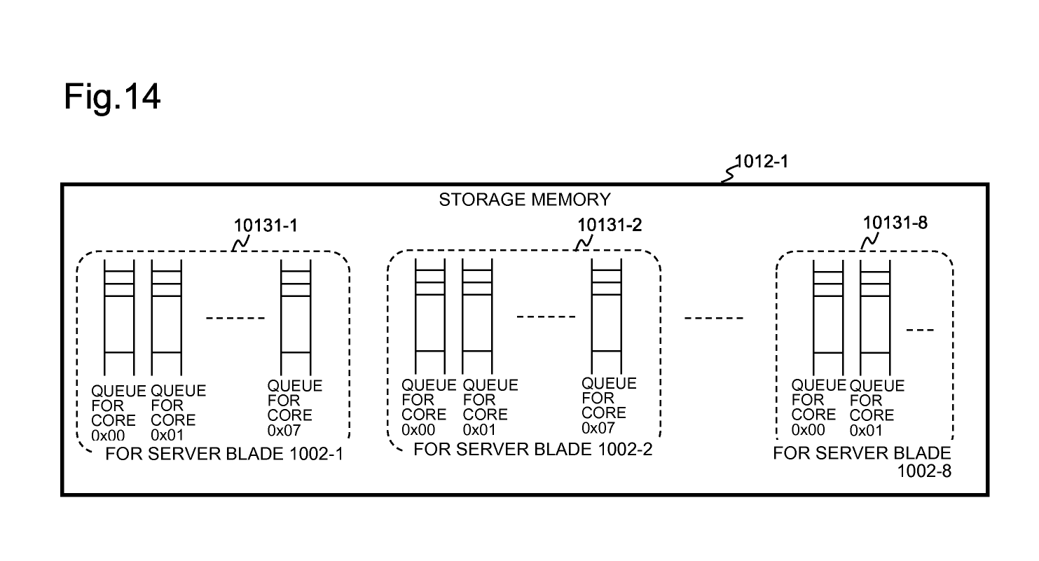

A FIFO-type area for storing an I/O command that the server blade 1002 issues to the controller 1001 is formed in the storage memories 1012-1 and 1012-2, and this area is called a command queue in Embodiment 2. FIG. 14 illustrates an example of the command queue provided in the storage memory 1012-1. As shown in FIG. 14, the command queue is formed to correspond to each server blade 1002, and to each processor core of the controller 1001. For example, when the server blade 1002-1 issues an I/O command with respect to an LU whose ownership is owned by the processor core (core 0x01) having identification number 0x01, the server blade 1002-1 stores the command in a queue for core 0x01 within a command queue assembly 10131-1 for the server blade 1002-1. Similarly, the storage memory 1012-2 has a command queue corresponding to each server blade, but the command queue provided in the storage memory 1012-2 differs from the command queue provided in the storage memory 1012-1 in that it is a queue storing a command for a processor core provided in the MPU 1011-2, that is, for a processor core having identification numbers 0x08 through 0x0F.

### (Dispatch Table)

The controller 1001 according to Embodiment 2 also has a dispatch table 241, similar to the controller 21 of Embodiment 1. The content of the dispatch table 241 is similar to that described with reference to Embodiment 1 (FIG. 5). The difference is that in the dispatch table 241 of Embodiment 2, identification numbers (0x00 through 0x0F) of the processor cores are stored in the MPU #502, and the other points are the same as the dispatch table of Embodiment 1.

In Embodiment 1, a single dispatch table 241 exists within the controller 21, but in the controller 1001 of Embodiment 2, a number of dispatch tables equal to the number of the server blades 1002 are stored therein (for example, if two servers blades, server blade 1002-1 and 1002-2, exist, a total of two dispatch tables, a dispatch table for server blade 1002-1 and a dispatch table for server blade 1002-2, are stored in the controller 1001). Similar to Embodiment 1, the controller 1001 creates a dispatch table 241 (allocates a storage area for storing the dispatch table 241 in the storage memory 1012 and initializing the content thereof) when starting the computer system 1000, and notifies a base address of the dispatch table to the server blade 1002 (supposedly referred to as server blade 1002-1) (FIG. 3: processing of S1). At this time, the controller generates a base address based on a top address in the storage memory 1012 storing the dispatch table to be accessed by the server blade 1002-1 out of the multiple dispatch tables, and notifies the generated base address. Thereby, when determining the issue destination of the I/O command, the server blades 1002-1 through 1002-8 can access the dispatch table that it should access out of the eight dispatch tables stored in the controller 1001. The position for storing the dispatch table 241 in the storage memory 1012 can be determined statically in advance or can be determined dynamically by the controller 10012 when generating the dispatch table.

### (Index Table)

According to the storage controller 21 of Embodiment 1, an 8-bit index number has been derived based on the information (S_ID) of the servers (or the virtual computer operating in the server 3) contained in the I/O command, and the server 3 had determined the access destination within the dispatch table using the index number. Then, the controller 21 had managed the information on the corresponding relationship between the S_ID and the index number in the index table 600. Similarly, the controller 1001 according to Embodiment 2 also retains the index table 600, and manages the correspondence relationship information between the S_ID and the index number.

Similar to the dispatch table, the controller 1001 according to the Embodiment 2 also manages the index table 600 for each server blade 1002 connected to the controller 1001. Therefore, it has the same number of index tables 600 as the number of the server blades 1002.

### (Blade Server-Side Management Information)

The information maintained and managed by a blade server 1002 for performing I/O dispatch processing according to Embodiment 2 of the present invention is the same as the information (search data table 3010, dispatch table base address information 3110, and dispatch table read destination CTL # information 3120) that the server 3 (the dispatch unit 35 thereof) of Embodiment 1 stores. In the blade server 1002 of Embodiment 2, these information are stored in the internal RAM 10246 of the ASIC 1024.

### (I/O Processing Flow)

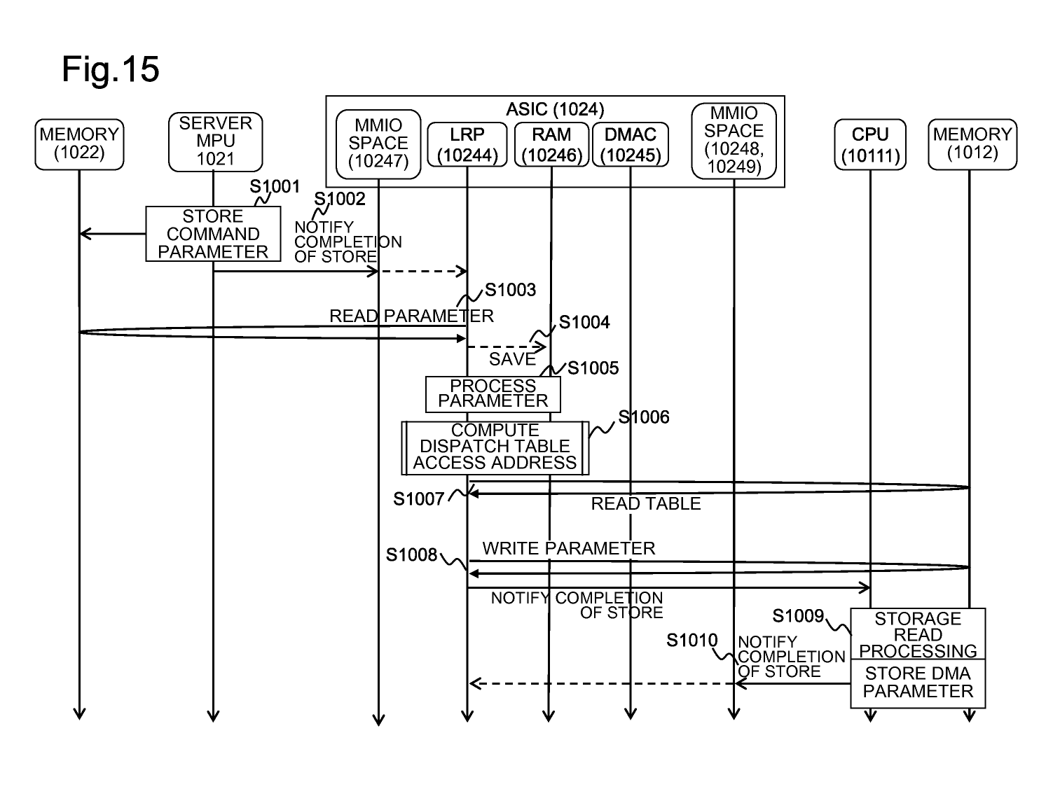

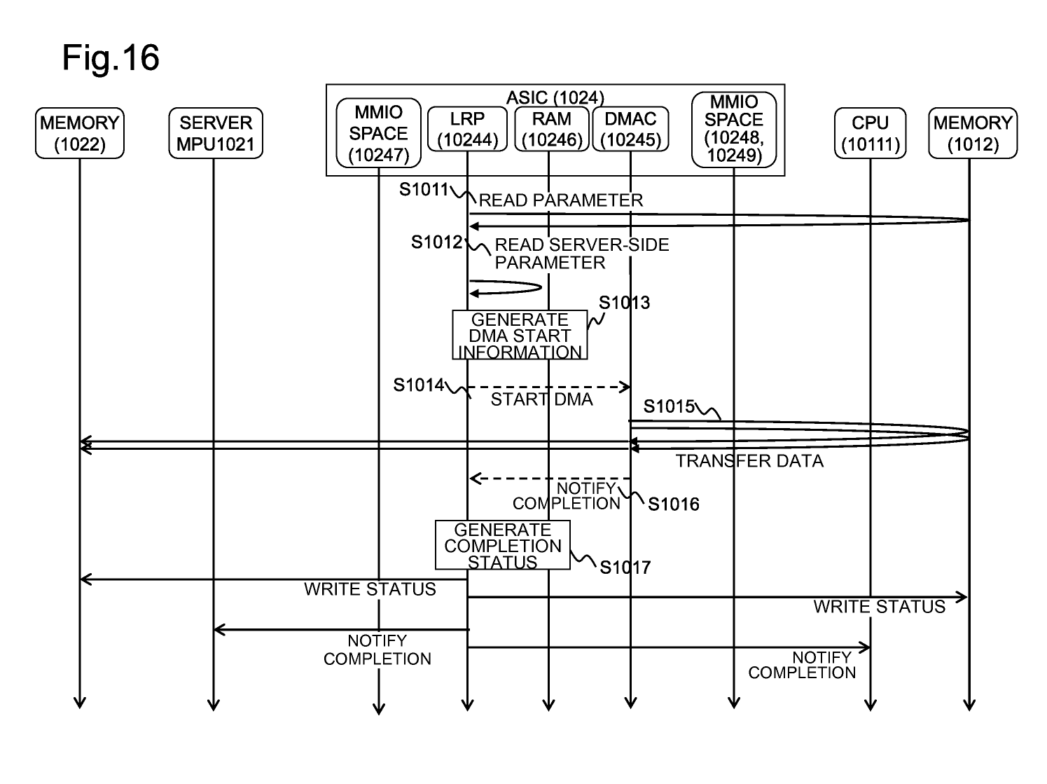

Next, with reference to FIGS. 15 and 16, we will describe the outline of the processing performed when the server blade 1002 transmits an I/O request (taking a read request as an example) to the storage controller module 1001. The flow of this processing is similar to the flow illustrated in FIG. 3 of Embodiment 1. Also according to the computer system 1000 of Embodiment 2, during the initial setting, the processes of S1 and S2 (creation of a dispatch table, read destination of the dispatch table, and transmission of the dispatch table base address information) of FIG. 3 is performed, but the processes are not shown in the drawings of FIGS. 15 and 16.

At first, the MPU 1021 of the server blade 1002 generates an I/O command (S1001). Similar to Embodiment 1, the parameter of the I/O command includes S_ID which is information capable of specifying the transmission source server blade 1002, and a LUN of the access target LU. In a read request, the parameter of the I/O command includes an address in the memory 1022 to which the read data should be stored. The MPU 1021 stores the parameter of the generated I/O command in the memory 1022. After storing the parameter of the I/O command in the memory 1022, the MPU 1021 notifies that the storage of the I/O command has been completed to the ASIC 1024 (S1002). At this time, the MPU 1021 writes information to a given address of the MMIO space for server 10247 to thereby send a notice to the ASIC 1024.

The processor (LRP 10244) of the ASIC 1024 having received the notice that the storage of the command has been completed from the MPU 1021 reads the parameter of the I/O command from the memory 1022, stores the same in the internal RAM 10246 of the ASIC 1024 (S1004), and processes the parameter (S1005). The format of the command parameter differs between the server blade 1002-side and the storage controller module 1001-side (for example, the command parameter created in the server blade 1002 includes a read data storage destination memory address, but this parameter is not necessary in the storage controller module 1001), so that a process of removing information unnecessary for the storage controller module 1001 is performed.

In S1006, the LRP 10244 of the ASIC 1024 computes the access address of the dispatch table 241. This process is the same process as that of S4 (S41 through S45) described in FIGS. 3 and 7 of Embodiment 1, based on which the LRP 10244 acquires the index number corresponding to the S_ID included in the I/O command from the search data table 3010, and computes the access address. Embodiment 2 is also similar to Embodiment 1 in that the search of the index number may fail and the computation of the access address may not succeed, and in that case, the LRP 10244 generates a dummy address, similar to Embodiment 1.

In S1007, a process similar to S6 of FIG. 3 is performed. The LRP 10244 reads the information in a given address (access address of dispatch table 241 computed in S1006) of the dispatch table 241 of the controller 1001 (1001-1 or 1001-2) specified by the table read destination CTL #3120. Thereby, the processor (processor core) having ownership of the access target LU is determined.

S1008 is a process similar to S7 (FIG. 3) of Embodiment 1. The LRP 10244 writes the command parameter processed in S1005 to the storage memory 1012. In FIG. 15, only an example where the controller 1001 which is the read destination of the dispatch table in the process of S1007 is the same as the controller 1001 which is the write destination of the command parameter in the process of S1008 is illustrated. However, similar to Embodiment 1, there may be a case where the controller 1001 to which the processor core having ownership of the access target LU determined in S1007 differs from the controller 1001 being the read destination of the dispatch table, and in that case, the write destination of the command parameter would naturally be the storage memory 1012 in the controller 1001 to which the processor core having ownership of the access target LU belongs.

Further, since multiple processor cores 10111 exist in the controller 1001 of Embodiment 2, it is determined that the identification number of the processor core having ownership of the access target LU determined in S1007 is within the range of 0x00 to 0x07 or within the range of 0x08 to 0x0F, wherein if the identification number is within the range of 0x00 to 0x07, the command parameter is written in the command queue provided in the storage memory 1012-1 of the controller 1001-1, and if it is within the range of 0x08 to 0x0F, the command parameter is written in the command queue disposed in the storage memory 1012-2 of the controller 1001-2.

For example, if the identification number of the processor core having ownership of the access target LU determined in S1007 is 0x01, and the server blade issuing the command is server blade 1002-1, the LRP 10244 stores the command parameter in the command queue for core 0x01 out of the eight command queues for the server blade 1002-1 disposed in the storage memory 1012. After storing the command parameter, the LRP 10244 notifies that the storing of the command parameter has been completed to the processor core 10111 (processor core having ownership of the access target LU) of the storage controller module 1001.

Embodiment 2 is similar to Embodiment 1 in that in the process of S1007, the search of the index number may fail since the S_ID of the server blade 1002 (or the virtual computer operating in the server blade 1002) is not registered in the search data table in the ASIC 1024, and as a result, the processor core having ownership of the access target LU may not be determined. In that case, similar to Embodiment 1, the LRP 10244 transmits an I/O command to a specific processor core determined in advance (this processor core is called a “representative MP”, similar to Embodiment 1). That is, a command parameter is stored in the command queue for the representative MP, and after storing the command parameter, a notification notifying that the storage of the command parameter has been completed is sent to the representative MP.

In S1009, the processor core 10111 of the storage controller module 1001 acquires an I/O command parameter from the command queue, and based on the acquired I/O command parameter, prepares the read data. Specifically, the processor core reads data from the HDD 1007, and stores the same in the cache area of the storage memory 1012. In S1010, the processor core 10111 generates a parameter for transferring DMA for transferring the read data stored in the cache area, and stores the same in its own storage memory 1012. When storage of the parameter for transferring the DMA is completed, the processor core 10111 notifies that storage has been completed to the LRP 10244 of the ASIC 1024 (S1010). This notice is specifically realized by writing information in a given address of the MMIO space (10248 or 10249) for the controller 1001.

In S1011, the LRP 10244 reads a DMA transfer parameter from the storage memory 1012. Next, in S1012, the I/O command parameter saved in S1004 is read from the server blade 1002. The DMA transfer parameter read in S1011 includes a transfer source memory address (address in storage memory 1012) in which the read data is stored, and the I/O command parameter from the server blade 1002 includes a transfer destination memory address (address in the memory 1022 of the server blade 1002) of the read data, so that in S1013, the LRP 10244 generates a DMA transfer list for transferring the read data in the storage memory 1012 to the memory 1022 of the server blade 1002 using these information, and stores the same in the internal RAM 10246. Thereafter in S1014, when the LRP 10244 instructs the DMA controller 10245 to start DMA transfer, then in S1013, the DMA controller 10245 executes data transfer to the memory 1022 of the server blade 1002 from the storage memory 1012 based on the DMA transfer list stored in the internal RAM 10246 (S1015).

When data transfer in S1015 is completed, the DMA controller 10245 notifies that data transfer has been completed to the LRP 10244 (S1016). When the LRP 10244 receives notice that data transfer has been completed, it creates a status information of completion of I/O command, and writes the status information into the memory 1022 of the server blade 1002 and the storage memory 1012 of the storage controller module 1001 (S1017). Further, the LRP 10244 notifies that the processing has been completed to the MPU 1021 of the server blade 1002 and the processor core 10111 of the storage controller module 1001, and completes the read processing.

(Processing Performed when Search of Index Number has Failed)

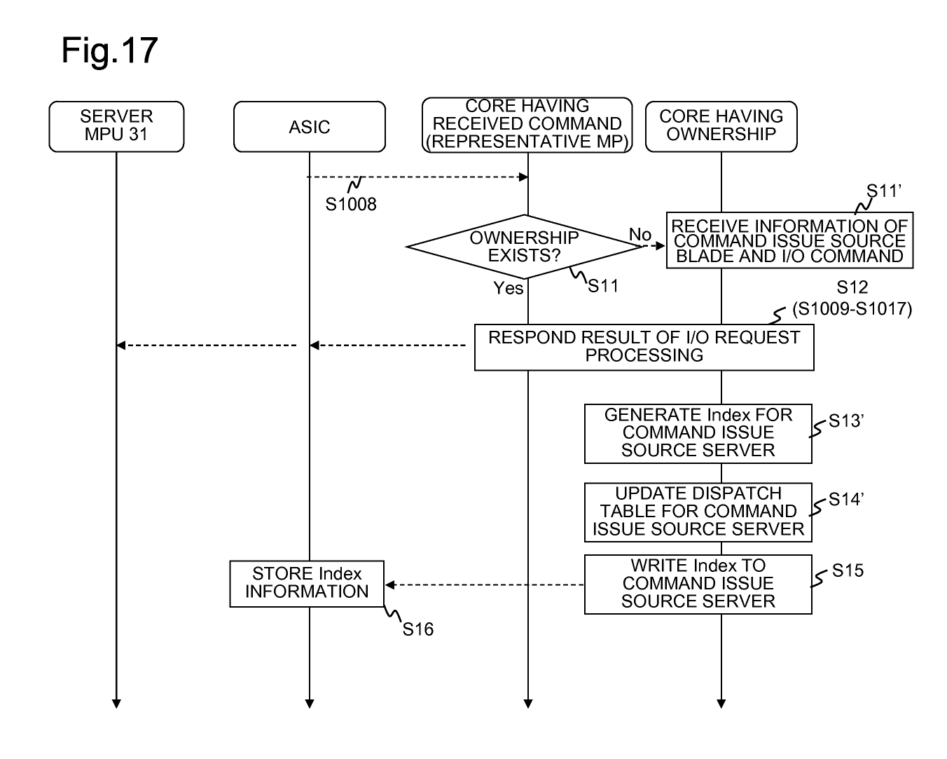

Next, we will describe the processing performed when the search of the index number has failed (such as when the server blade 1002 (or the virtual computer operating in the server blade 1002) first issues an I/O request to the controller 1002), with reference to FIG. 17. This process is similar to the processing of FIG. 8 according to Embodiment 1.

When the representative MP receives an I/O command (corresponding to S1008 of FIG. 15), it refers to the S_ID and the LUN included in the I/O command and the LDEV management table 200 to determine whether it has the ownership of the access target LU or not (S11). If the MP has the ownership, it performs the processing of S12 by itself, but if it does not have the ownership, the representative MP transfers the I/O command to the processor core having the ownership, and the processor core having the ownership receives the I/O command from the representative MP (S11). Further, when the representative MP transmits the I/O command, it also transmits the information of the server blade 1002 that issued the I/O command (information indicating which of the server blades 1002-1 through 1002-8 has issued the command).

In S12, the processor core processes the received I/O request, and returns the result of processing to the server 3. In S12, when the processor core having received the I/O command has the ownership, the processes of S1009 through S1017 illustrated in FIGS. 15 and 16 are performed. If the processor core having received the I/O command does not have the ownership, the processor core to which the I/O command has been transferred (the processor core having ownership) executes the process of S1009, and transfers the data to the controller 1001 in which the representative MP exists, so that the processes subsequent to S1010 is executed by the representative MP.

The processes of S13′ and thereafter are similar to the processes of S13 (FIG. 8) and thereafter according to Embodiment 1. In the controller 1001 of Embodiment 2, if the processor core having ownership of the volume designated by the I/O command received in S1008 differs from the processor core having received the I/O command, the processor core having the ownership performs the processes of S13′ and thereafter. The flow of processes in that case is described in FIG. 17. However, as another embodiment, the processor core having received the I/O command may perform the processes of S13′ and thereafter.

When mapping the S_ID included in the I/O command processed up to S12 to the index number, the processor core refers to the index table 600 for the server blade 1002 of the command issue source, searches for the index number not mapped to any S_ID, and selects one of the index numbers. In order to specify the index table 600 for the server blade 1002 of the command issue source, the processor core performing the process of S13′ receives information specifying the server blade 1002 of the command issue source from the processor core (representative MP) having received the I/O command in S11′. Then, the S_ID included in the I/O command is registered to the S_ID 601 field of the row corresponding to the selected index number (index #602).

The process of S14′ is similar to S14 (FIG. 8) of Embodiment 1, but since a dispatch table 241 exists for each server blade 1002, it differs from Embodiment 1 in that the dispatch table 241 for the server blade 1002 of the command issue source is updated.

Finally in S15, the processor core writes the information of the index number mapped to the S_ID in S13 to the search data table 3010 within the ASIC 1024 of the command issue source server blade 1002. As mentioned earlier, since the MPU 1011 (and the processor core 10111) of the controller 1001 cannot write data directly to the search data table 3010 in the internal RAM 10246, the processor core writes data to a given address within the MMIO space for CTL1 10248 (or the MMIO space for CTL2 10249), based on which the information of the S_ID is reflected in the search data table 3010.

### (Multiprocessing of Command)

In Embodiment 1, it has been described that while the dispatch module 33 receives a first command from the MPU 31 of the server 3 and performs a determination processing of the transmission destination of the first command, the module can receive a second command from the MPU 31 and process the same. Similarly, the ASIC 1024 of Embodiment 2 can process multiple commands at the same time, and this processing is the same as the processing of FIG. 9 of Embodiment 1.

(Processing Performed when Generation of LU, Processing Performed when Failure Occurs)

Also in the computer system of Embodiment 2, the processing performed during generation of LU and the processing performed when failure occurs in Embodiment 1 are performed similarly. The flow of processing is the same as Embodiment 1, so that the detailed description thereof will be omitted. During the processing, a process to determine the ownership information is performed, but in the computer system of Embodiment 2, the ownership of the LU is owned by the processor core, so that when determining ownership, the controller 1001 selects any one of the processor cores 10111 within the controller 1001 instead of the MPU 1011, which differs from the processing performed in Embodiment 1.

Especially when failure occurs, in the process performed in Embodiment 1, when the controller 21a stops by failure, for example, there is no other controller capable of being in charge of the processing within the storage system 2 than the controller 21b, so that the ownership information of all volumes whose ownership had belonged to the controller 21a (the MPU 23a thereof) is changed to the controller 21b. On the other hand, according to the computer system 1000 of Embodiment 2, when one of the controllers (such as the controller 1001-1) stops, there are multiple processor cores capable of being in charge of processing of the respective volumes (the eight processor cores 10111 in the controller 1001-2 can be in charge of the processes). Therefore, in the processing performed when failure occurs according to Embodiment 2, when one of the controllers (such as the controller 1001-1) stops, the remaining controller (controller 1001-2) changes the ownership information of the respective volumes to any one of the eight processor cores 10111 included therein. The other processes are the same as the processes described with reference to Embodiment 1.

The preferred embodiments of the present invention have been described, but they are a mere example for illustrating the present invention, and they are not intended to restrict the present invention to the illustrated embodiments. The present invention can be implemented in other various forms. For example, in the storage system 2 illustrated in Embodiment 1, the numbers controllers 21, ports 26 and disk I/Fs 215 in the storage system 2 are not restricted to the numbers illustrated in FIG. 1, and the system can adopt two or more controllers 21 and disk I/Fs 215, or three or more host I/Fs. The present invention is also effective in a configuration where the HDDs 22 are replaced with other storage media such as SSDs.

Further, the present embodiment adopts a configuration where the dispatch table 241 is stored within the memory of the storage system 2, but a configuration can be adopted where the dispatch table is disposed within the dispatch module 33 (or the ASIC 1024). In that case, when update of the dispatch table occurs (as described in the above embodiment, such as when an initial I/O access has been issued from the server to the storage system, when an LU is defined in the storage system, or when failure of the controller occurs), an updated dispatch table is created in the storage system, and the update result can be reflected from the storage system to the dispatch module 33 (or the ASIC 1024).

Further according to Embodiment 1, the dispatch module 33 can be mounted to the ASIC (Application Specific Integrated Circuit) or the FPGA (Field Programmable Gate Array), or can have a general-purpose processor loaded within the dispatch module 33, so that the large number of processes performed in the dispatch module 33 can be realized by a program running in the general-purpose processor.

### REFERENCE SIGNS LIST

1: Computer system
2: Storage system
3: Server
4: Management terminal
6: LAN
7: I/O bus
21: Storage controller
22: HDD
23: MPU
24: Memory
25: Disk interface
26: Port
27: Controller-to-controller connection path
31: MPU
32: Memory
33: Dispatch module
34: Interconnection switch
35: Dispatch Unit
36, 37: Port

1. A computer system comprising one or more servers and a storage system;
the storage system comprising one or more storage media, a first controller having a first processor and a first memory, and a second controller having a second processor and a second memory, wherein the first controller and the second controller are both connected to the server;
the server comprising a third processor and a third memory, and a dispatch module for transmitting an I/O request to the storage system issued by the third processor to either the first processor or the second processor;
the dispatch module is caused to
start a process to determine which of the first processor or the second processor should be set as a transmission destination of a first I/O request based on a dispatch information provided by the storage system when the third processor issues the first I/O request;
start a process to determine which of the first processor or the second processor should be set as a transmission destination of a second I/O request based on a dispatch information provided by the storage system when the second I/O request is received from the third processor before the transmission destination of the first I/O request is determined;
transmit the first I/O request to the determined transmission destination when the transmission destination of the first I/O request is determined; and
not transmit the second I/O request to the transmission destination until the transmission destination of the first I/O request is determined.

2. The computer system according to claim 1, wherein
the storage system stores in the first memory or the second memory a dispatch table storing information regarding the transmission destination of the I/O request of the server; and
when an I/O request is received from the third processor, the dispatch module acquires the information stored in the dispatch table, and determines which of the first processor or the second processor should be set as the transmission destination of the I/O request based on the information.

3. The computer system according to claim 2, wherein
the storage system provides multiple volumes composed of one or more storage media to the server;
the I/O request issued from the third processor at least includes a unique identifier provided to the server, and a logical unit number (LUN) of the volume provided by the storage system;
the dispatch table stores information regarding the transmission destination of the I/O request for each volume; wherein
the dispatch module
has a search data table storing information regarding a correspondence relationship between the identifier and an index number mapped to the identifier;
when the first I/O request is received from the third processor, refers to the search data table, and when the identifier exists in the search data table, specifies the index number based on the identifier;
determines a reference destination address within the dispatch table based on the specified index number and a LUN included in the first I/O request, and acquires information on the transmission destination of the first I/O request by reading information stored in an area in the first memory or the second memory specified by the reference destination address; and
determines which of the first processor or the second processor should be set as a transmission destination of the first I/O request based on the acquired information.

4. The computer system according to claim 3, wherein
in the computer system, a representative processor information which is information on the transmission destination of the I/O request when an index number mapped to the identifier of the server does not exist in the search data table is defined in advance;
when the second I/O request is received from the third processor, the dispatch module refers to the search data table, and if the identifier included in the second I/O request does not exist in the search data table, executes reading of data of a given area in the first memory or the second memory, and thereafter, transmits the second I/O request to a transmission destination specified by the representative processor information.

5. The computer system according to claim 4, wherein
after returning a response to the second I/O request to the server, the storage system
determines an index number to be mapped to the identifier, and stores the determined index number mapped with the identifier in the search data table.

6. The computer system according to claim 3, wherein
in the storage system, a processor in charge of processing an I/O request to the volume is determined for each volume; and
information regarding a transmission destination of the I/O request for each volume stored in the dispatch table is information regarding the processor in charge of the I/O request for each volume.

7. The computer system according to claim 2, wherein
the first processor and the second processor respectively include multiple processor cores; and
when an I/O request is received from the third processor, the dispatch module acquires the information stored in the dispatch table, and based on the information, determines which processor core out of the multiple processor cores in the first processor or the second processor should be set as the transmission destination of the I/O request.

8. A method for controlling a computer system comprising one or more servers and a storage system;
the storage system comprising one or more storage media, a first controller having a first processor and a first memory, and a second controller having a second processor and a second memory, wherein the first controller and the second controller are both connected to the server;
the server comprising a third processor and a third memory, and a dispatch module for transmitting an I/O request to the storage system issued by the third processor to either the first processor or the second processor;
the dispatch module is caused to
start a process to determine which of the first processor or the second processor should be set as a transmission destination of a first I/O request based on a dispatch information provided by the storage system when the third processor issues the first I/O request;
start a process to determine which of the first processor or the second processor should be set as a transmission destination of a second I/O request based on a dispatch information provided by the storage system when the second I/O request is received from the third processor before the transmission destination of the first I/O request is determined;
transmit the first I/O request to the determined transmission destination when the transmission destination of the first I/O request is determined; and
not transmit the second I/O request to the transmission destination until the transmission destination of the first I/O request is determined.

9. The method for controlling a computer system according to claim 8, wherein
the storage system stores in the first memory or the second memory a dispatch table storing information regarding the transmission destination of the I/O request of the server; and
when an I/O request is received from the third processor, the dispatch module acquires the information stored in the dispatch table, and determines which of the first processor or the second processor should be set as the transmission destination of the I/O request based on the information.

10. The method for controlling a computer system according to claim 9, wherein
the storage system provides multiple volumes composed of one or more storage media to the server;
the I/O request issued from the third processor at least includes a unique identifier provided to the server, and a logical unit number (LUN) of the volume provided by the storage system;
the dispatch table stores information regarding the transmission destination of the I/O request for each volume; wherein
the dispatch module has a search data table storing information regarding a correspondence relationship between the identifier and an index number mapped to the identifier; and
the dispatch module
refers to the search data table when a first I/O request is received from the third processor, and when the identifier exists in the search data table, specifies the index number based on the identifier;
determines a reference destination address within the dispatch table based on the specified index number and a LUN included in the first I/O request, and acquires information on the transmission destination of the first I/O request by reading information stored in an area in the first memory or the second memory specified by the reference destination address; and
determines which of the first processor or the second processor should be set as a transmission destination of the first I/O request based on the acquired information.

11. The method for controlling a computer system according to claim 10, wherein
in the computer system, a representative processor information which is information on the transmission destination of the I/O request when an index number mapped to the identifier of the server does not exist in the search data table is defined in advance;
when the second I/O request is received from the third processor, the dispatch module refers to the search data table, and if the identifier included in the second I/O request does not exist in the search data table, executes reading of data of a given area in the first memory or the second memory, and thereafter, transmits the second I/O request to a transmission destination specified by the representative processor information.

12. The method for controlling a computer system according to claim 11, wherein
after returning a response to the second I/O request to the server, the storage system
determines an index number to be mapped to the identifier, and stores the determined index number mapped with the identifier in the search data table.

13. The method for controlling a computer system according to claim 10, wherein
in the storage system, a processor in charge of processing an I/O request to the volume is determined for each volume; and
information regarding a transmission destination of the I/O request for each volume stored in the dispatch table is information regarding the processor in charge of the I/O request for each volume.

14. The method for controlling a computer system according to claim 9, wherein
the first processor and the second processor respectively include multiple processor cores; and
when an I/O request is received from the third processor, the dispatch module acquires the information stored in the dispatch table, and based on the information, determines which processor core out of the multiple processor cores in the first processor or the second processor should be set as the transmission destination of the I/O request.
